(19) United States
(12) Patent Application Publication
(10) Pub. No.: US 2013/0333981 A1
(43) Pub. Date: Dec. 19, 2013

(54) Gravity Transforming Method

(71) Applicants: Keren Wang, Shenzhen (CN); Wenlin Ren, Wuhan (CN)

(72) Inventors: Keren Wang, Shenzhen (CN); Wenlin Ren, Wuhan (CN)

(21) Appl. No.: 14/002,729

(22) PCT Filed: Mar. 5, 2012
(86) PCT No.: PCT/CN2012/000272

§ 371 Date: Sep. 2, 2013

(30) Foreign Application Priority Data
Mar. 4, 2011 (CN) 201120056501.3
Apr. 27, 2011 (CN) 201120127794.X

(51) Int. Cl. F03G 3/00

(52) U.S. Cl. CPC F03G 3/00; Y10S 74/09
USPC 185/29; 185/27; 74/DIG. 9

(57) ABSTRACT

Disclosed is a gravity transforming method which comprises: establishing a circumference body (1); installing a driving device of the circumference body (1) on the top of the circumference body (1) for moving the circumference body (1); installing a gravity output device in the potential energy area of the circumference body (1) for transferring the gravity of the circumference body (1) to gear box, a receiving wheel, a lever, a convex point or a flywheel. The gravity energy of the circumference body (1) is outputted and transformed into an available power by the gravity output device. During the movement of the circumference body, the output energy is greater than the input energy.

### BACKGROUND OF THE PRESENT INVENTION

1. Field of Invention

The present invention belongs to field of gravity transforming method and new energy, specifically method of obtaining gravity energy and application of the gravity energy, including gravity transforming devices like gravity engine.

2. Description of Related Arts

Nowadays, people are facing so many crises, for example, energy crisis and environment crisis. Researches show that the environment crisis is caused by fossil energy pollution. If we keep on using the fossil energy, the environment will be continuously deteriorated, which will endanger safety and living of human being. Experts warn that the human beings have only the last seven years to save the environment, with the last year being 2017. The most critical moment for human beings to save the environment has come, and the human beings must take action immediately; however, no good measure to deal with such problem has been raised so far all over the world. Kyoto Protocol has been signed for several decades, but it fails to bring good result. And either of Copenhagen conference, Cancun Conference or Durban Conference could propose any measure. For decades, people fail to resolve the environment crisis and save the future of human beings. At present, people are still using fossil energy as the main energy. But the fossil energy is the limited resources which require high cost and cause severe pollution. Although hydraulic power and wind power could be used as energy, limited by the environment and cost, they cannot replace the fossil energy to be the main energy. The cost for human beings to get and use the energy is too high. On the one hand, there is severe energy crisis; on the other hand, there are abundant gravity resources but people cannot use such resources. The gravity resources, which are clean, cheap, environment-friendly, inexhaustible, ubiquitous and easy to obtain, are the gift from nature. Because the basic law and theory of gravity energy is not found, the method to obtain the gravity energy is incorrect, and the gravity energy cannot be used effectively so far. There are many inventions about the gravity energy as claimed in the prior art, but none of them are successful; for example, patent 200480016130.9 and 200610152917.9. The sign of success includes that: input is less than output, and at least it is able to use gravity to improve efficiency of using or transforming energy. However, the two points are never met. If the two points are met, human beings will not suffer the energy crisis or environment crisis, and energy wars could be prevented. Restricted by traditional theory, people have prejudices on the theory and technique, which influences gravity transformation and new energy discovery.

Circular motion is a common motion. Human beings have certain knowledge about this, and have invented wheel, pulley, lever, bicycle, automobile, train and so on. However, research to the circular motion lacks of theory breakthrough, which causes insufficient innovation. The main body of circular motion is circumferential body which includes sphere, cylinder and wheel and so on. The circular motion includes rolling and rotating. And swinging, swaying and shaking are local circular motion, the main bodies of which are also circumferential body. All bodies having radius movement (namely, the radius rotates around the centre of a circle, including rotating to a certain angle), and the movement thereof is circular motion.

The specification contains further statement of the background art and effect of the present invention in combination with relating content below.

### SUMMARY OF THE PRESENT INVENTION

Targets of the present invention includes the following: firstly, overcome the defects of the prior art, and provide a circular motion method using scientific law and solid altitude gravitational potential energy of circumferential body, and provide method of obtaining gravity energy using circular motion as well as the device and application thereof, thus to provide the gravity energy that is good in performance, low in cost, convenient in use, clean and safe. It is expected to replace the fossil energy with the gravity energy, so as to restore ecological health of the earth and the human environment. Secondly, even if the first target cannot be realized, at least improve efficiency of using and transforming energy by using gravity, to be “a method and device to improve efficiency of using and transforming energy by using gravity”. Thirdly, provide more energy saving methods using the new theory of circular motion. Fourthly, reduce cost, including cost of obtaining and using energy. The inventor had claimed the first to third laws of the “Circumference Law” and gravity vehicle in the China patent application 200710145154.X named Gravity vehicle on 25 Aug. 2006. The present invention has more contents, including new fourth to sixth laws of the “Circumference Law”, gravity transforming method, gravity generation device, and gravity engine. The “Circumference Law” is the basis for the theory and claims of the present invention.

### Circumference Law (Circular Motion Law)

The First Law

In the gravitational field, when a circumferential body of uniform mass (sphere or cylinder) is in point contact or line contact with a rigid and horizontal bearing surface in ideal condition, the gravity divides the mass of the circumferential body into two from the middle, separating surface of the two parts of mass is the gravity surface; the gravity at the both sides of the gravity surface is balanced and identical in strength but opposite in direction, being resistance or driving force of each other; in the motion state, there is always half of the gravity being the resistance or driving force; inertia force could be irrelevant to the mass; the possible situations could be as follows: no matter how great the mass is, the force to overcome the stationary inertia force is greater than zero, and the force to overcome the motion inertial force is greater than the external force applied to it.

Explanation to the First Law:

Said “uniform mass” refer to that the mass distribute uniformly. The circumferential bodies of non-uniform mass distribution also obey the Circumference Law to different degrees. Said “circumferential body” means bodies having gravity surface, including sphere, cylinder and non-circular body. The cylinder includes wheel type bodies. The non-circular body includes bodies having radius motion except sphere and cylinder. The non-circular body is circumferential body only when it is in radius motion. The radius motion includes rolling, rotating, swaying, swinging and shaking. Rolling could be without axle, but rotating requires the axle. Motion of roly-poly toy is swaying, motion of swing is swinging, motion of teeterboard is shaking, and motion of human walking is alternative swinging of legs and swaying of whole body. All circumferential bodies shall obey the Circumference Law. Said “rigid and horizontal bearing surface” means non-deformable horizontal bearing surface. Said “ideal condition” means that the bearing surface would not be recessed, and the contact radius which is the distance from the center of the circle to bearing surface of the circumferential body does not change; the contact radius concept is related to original radius which is the original radius of the circumferential body. For example, a wheel is a cylindrical circumferential body, and the contact between the wheel and the ground in ideal condition is line contact. But in actual the contact radius is always smaller than original radius, and the contact with ground is not the ideal line contact but surface contact, so the rolling resistance is big. The circumferential body in non-ideal condition obeys the Circumference Law to different degrees. The First Law is also called “Gravity Surface Law”. The “gravity surface” is also called “gravity separating surface”, which means the separating surface between two parts of gravity of the circumferential body in opposite direction. The gravity surface is always on the extension line of the line from fixed pivot of the circumferential body to geocenter. The gravity surface is invisible but objectively existing. The circumferential body in motion could automatically adjust the gravity at the both sides of the gravity surface, so as to make the two forces identical and balanced but opposite in direction. The application range of the “Gravity Surface Law” is wide. It could be used to explain the physical phenomenon like “standing peg-top”, “balancing bowls on the head” and “saving effort by rolling”. The First Law is the basis of the Circumference Law, and the following laws are all extended according to the First Law.

The Second Law

According to the First Law, possible situations could be as follows: acceleration of circumferential body generated by the stressed force (sphere or cylinder) is in direct proportion to the stressed force, but irrelevant to its mass; in case of the same stressed force, the circumferential bodies of different mass could generate same acceleration.

When the horizontal bearing surface of the First Law becomes an inclined-plane, possible situations could be as follows:

When the gravity surface of a circumferential body on an ascending trend on the inclined-plane is at a position across the circle center, the gravity at both sides of the gravity surface is not identical, then the gravity becomes resistance; the acceleration of circumferential body generated by the stressed force is in direct proportion to the stressed force, but in inverse proportion to its mass;

When the gravity surface of a circumferential body on a descending trend on the inclined-plane is at a position across the circle center, the gravity at both sides of the gravity surface is not identical, then the gravity becomes driving force; the acceleration of circumferential body generated by the stressed force is in direct proportion to the stressed force, and also in direct proportion to its mass;

The circumferential body on the inclined-plane, no matter it is ascending or descending, the gravity surface is always on the extension line of the line from fixed pivot of the circumferential body to geocenter;

The motion type of the circumferential body, which is rolling and changing the spatial position rapidly, is composite motion and does not fully obey the Circumference Law. The faster it rolls to change the spatial position, the more it disobeys the Circumference Law.

The circumferential body rotating around an axle has a function of accumulating energy while rotating. No matter how great the mass is, the force to overcome the stationary inertia force is bigger than the friction force of bearing, and the force to overcome the motion inertia is bigger than the force applied to it.

The Third Law

According to the First Law, when a force is stressed to the circumferential body, possible situations could be as follows:

When the fixed pivot of the force is on the ground, the centre of gravity is on the circle center, point of force is at top of the circle, and power arm is identical to resisting arm in length, half of the force could be saved, which obeys the principle of movable pulley. The vehicle wheel which uses rim transmission belongs to this type.

When the fixed pivot of the force is on the ground, the centre of gravity is lower than the circle center, point of force is at top of the circle, and power arm is longer than resisting arm, more than half of the force could be saved, which obeys the lever principle. The vehicle wheel which uses big wheel transmission belongs to this type.

When a wheel carries weight through a swinging structure, the weight could swing relative to the wheel; when the gravity surface of the wheel swings along the weight, more than half of the gravity becomes resistance or driving force; theoretically, the force to overcome the stationary inertia force of the wheel (including the weight) is greater than friction force of the swinging axle. (For more information about rim transmission, big wheel transmission and swinging structure, refer to my previous patent application “Gravity Vehicle”.)

The Fourth Law

The circumferential body has a solid altitude gravitational potential energy and a solid altitude gravitational potential energy zone. The area underneath the circumferential body (including noncontact area around the contacting point or at both sides of contact line) is the solid altitude gravitational potential energy zone, which is called “potential energy zone” for short. The gravity energy of the circumferential body could be output on the circumferential body or in the potential energy zone of the circumferential body. The solid altitude gravitational potential energy could be maintained forever in horizontal rolling state.

Compared to fluid, the solid altitude gravitational potential energy density of the circumferential body is greater, more widely spread, easier to collect and more environment-friendly.

The solid altitude gravitational potential energy density of the circumferential body is inherent natural law.

The Fifth Law

The gravity of the rolling circumferential body at two gravity surfaces changes continuously; the more gravity changes into driving force, the more effort could be saved.

The rolling circumferential body could output same gravity energy to every point or every line of the way it rolls.

The rolling circumferential body could save half of force to ascend along a vertical surface, and the rolling circumferential body could save more than half of the force to ascend along an inclined-plane.

The input energy for the rolling circumferential body could be much smaller than the energy it outputs, and the rolling circumferential body could get the remaining energy.

The rolling circumferential body could create solid altitude gravitational potential energy, thus to be inexhaustible gravity energy.

The Sixth Law

The “gravity transforming device” could transform the solid altitude gravitational potential energy of the circumferential body into utilizable power.

The “gravity transforming device” includes protruding stud (convex point) arranged within the circumferential body potential energy zone. The protruding stud receives or transfers gravity of the circumferential body to transform the gravity into utilizable power. The protruding stud is higher than the bearing surface to form resistance to the rolling of the circumferential body. The force to roll the circumferential body becomes stronger along with height increase of the protruding stud. The higher the protruding stud is, the lower the energy efficiency is. And the lower the protruding stud is, the higher the energy efficiency is. As long as the protruding stud is in the potential energy zone of the circumferential body, it could transform gravity into power. As long as the force of the rolling circumferential body to press the protruding stud is less than gravity of the circumferential body, there is remaining energy generated. The remaining energy comes from the solid altitude gravitational potential energy density of the circumferential body, namely the continuous gravitational force from the earth to the circumferential body.

The way for the circumferential body to output gravity could be changed. And the structure of protruding stud could also be changed. For example, the protruding stud could be gear, connecting rod, lever or push rod. When the protruding stud is changed to connecting rod, the connecting rod could be connected to circle center of the circumferential body to provide transmission to crankshaft.

Explanation to the Circumference Law

There is a strange wind-blowing rock somewhere at the seashore, it sways when wind blows it. People are so surprised and confused with it and call it “magic rock”. Experts have different explanations but no one could explain this reasonably. However, the Circumference Law could explain it clearly: the wind-blowing rock is a non-circular circumferential body. There is an arc-shaped bottom surface at the bottom of the rock, and the contact between the rock and the lithoid bearing surface is a nearly ideal point or line contact. The gravity separating surface starting from this point or line upwards vertically is the “gravity surface” of the rock. The “Circumference Law” indicates that the gravity at the both sides of the gravity surface is identical in strength but opposite in direction, and the two are resistance or driving force of each other; and the force to overcome the stationary inertia force is greater than zero. According to this law, no matter how heavy the rock is, in theory, as long as there is a force greater than zero, the stationary inertia force thereof could be overcome, and the rock will be swayed. Even if the gravity at the both sides of the gravity surface is identical in strength but opposite in direction, being resistance or driving force of each other, the resistance and the driving force counteract, and the stationary inertia force is zero, so a force greater than zero is enough to overcome the stationary inertia force. The existence state of the wind-blowing rock conforms to motion state of the circumferential body, so its motion obeys the Circumference Law. Although the mass distribution and existence state of the rock cannot be an ideal condition, it automatically adjusts its state while swaying and gravity at both sides of the gravity surface, so that the gravity at both sides is identical but opposite in direction when it is stationary and the rock could reach or approach the ideal existence state of circular motion. The existence state of the wind-blowing rock is very close to the ideal condition. Therefore, a little force is enough to sway the wind-blowing rock. No matter how heavy the rock is, one ton, one hundred tons, or one hundred million tons, it would be the same. By this analysis, the fact is much clear that a gentle breeze could sway the huge rock. No matter whether the mass distribution is uniform or not, all circumferential bodies could automatically adjust the gravity surface and maintain the gravity at both sides of the gravity surfaces in motion. The self-adjustment capability of the circumferential body changes along with the change of the “contact radius” and “bearing surface”.

The circular motion does not obey the Newton's laws of Motion. Newton's First law of Motion is the inertia law: inertia of the bodies of low mass is small, while the inertia of the body of great mass is big, which means the mass determines the inertia force. Newton's Second Law of Motion is the acceleration law: the acceleration is in direct proportion to the strength of the force and in inverse proportion to mass. But phenomenon in the nature, for example, the wind-blowing rock phenomenon, does not obey the Newton's First Law of Motion and Newton's Second Law of Motion. The Newton's Law of Motion cannot reflect objective laws of the circular motion. For example, the body having great mass may not have big inertia. The wind-blowing rock is one of the examples: weight of the huge rock which is of hundreds tons, the mass and stationary inertia force thereof are great enough; according to the Newton's First law of Motion, it would not be moved easily. However, the natural phenomenon proves that the inertia is so small that even a gentle breeze could sway it. This is opposite to the Newton's laws of Motion. Are the Newton's laws of Motion wrong? Is the theory of mechanics incorrect? For more than one hundred years, the Newton's laws of Motion which are known as classic by the scientific community cannot reflect the objective laws accurately, what is wrong? There must be something that is not found, there must be a new law. That's why the Circumference Law comes. The Circumference Law proposes laws of mechanics that are completely opposite to the Newton's First Law of Motion and Newton's Second Law of Motion. Firstly, the Newton's Law of Motion proposes that inertia of a body is determined by the mass thereof. But the Circumference Law proposes that inertia of a body is irrelevant to the mass thereof. Secondly, the Newton's Law of Motion proposes that acceleration of a body is in direct proportion to the mass thereof. But the Circumference Law proposes that acceleration of a body is irrelevant to the mass thereof. On the circular motion, the Circumference Law is completely opposite to the Newton's Law of Motion. Which one is correct? This question could only be answered by the fact and practice.

The phenomenon of “wind-blowing rock” and the theory are the fact and practice: although weight of the “wind-blowing rock” is more than hundreds tons, because the lithoid base is very rigid (the bearing surface does not socket), and the wind-blowing rock itself is rigid (the contact radius does not become shorter), the bottom of the “wind-blowing rock” is almost in an ideal point or line contact with the bearing surface, a relatively ideal “circumferential body” is established. At both sides of the “gravity surface” of the circumferential body, the gravity is identical with each other and opposite in direction. And the gravity at both sides counteracts with each other and the stationary inertia force is equal to zero. So a very small force, greater than zero, is enough to overcome the stationary inertia force of the “wind-blowing rock”. Therefore, it's no surprise that “a gentle wind could sway the huge rock”. The fact and practice of the “wind-blowing rock” proves that the “Circumference Law” is correct. It is very important to establish the “gravity surface”. Motion of all bodies with the “gravity surface” established shall obey the Circumference Law.

The Circumference Law believes that: theoretically, no matter how great the mass of the circumferential body is, the force to overcome the stationary inertia force is greater than zero. Now that theoretically a force greater than zero could drive circumferential body of any weight, people should create tools that approaches the theoretical condition to serve human beings and improve the ability to adapt and utilize nature. Human being's discovery is always ahead of time and not accepted at the beginning, a cognition process is needed. New discovery of scientific theory plays a significant role in promoting development of productivity, just like the discovery of electricity to the world. At the very beginning, people thought that the electricity was the most useless discovery. But as we could see today, the electricity is the most useful discovery. The Circumference Law could provide new energy for human beings, and could save more than 50% of energy for the machinery or equipment which is in circular motion state. The Circumference Law is a scientific discovery, and the present invention is an application of the scientific discovery. Like other discoveries, the application of invention is always crude and childish at the beginning.

It does not matter whether or not there exists said ideal condition as stated in the First Law of the Circumference Law, it will not change the fact how we explain and understand the objective law. It is permissible and scientific for us to use an assumed ideal condition to explain the objective phenomenon in the circular motion and disclose the objective law of the circular motion. The reason to propose the “ideal condition” is to facilitate description and explanation, since it is difficult to describe the objective law of the natural phenomenon. At the same time, the circular motion in non-ideal condition varies, so we are not able to disclose them all. Therefore, it is an inevitable choice to use the law in ideal condition to disclose the laws in various non-ideal conditions. All circular motion, in non-ideal condition or ideal condition, obeys the Circumference Law in different degrees. Although the ideal condition is infinite, but in actual application, the difference between the ideal condition and non-ideal condition is very small, and even could be ignored. For example, the wind-blowing rock phenomenon, the difference between the ideal condition and non-ideal condition is very small.

All contents of the present invention, including the Circumference Law, are the support to the claims of the application.

All technical features of the present invention are not limited to one certain embodiment, but could be used separately or in combination.

The inventive content of the present invention includes the following claims.

1. A gravity transforming method, which is used to manufacture a gravity transforming device, wherein said method includes a driving device to drive the circumferential body to create gravitational potential energy, and a gravity transforming device is provided to transform the gravitational potential energy of the circumferential body into utilizable power;

Or, wherein a driving device is provided to drive the circumferential body to create gravitational potential energy, and a gravity transforming device to transfer the gravitational potential energy of the circumferential body to a flywheel; or, the gravitational potential energy of the circumferential body is accumulated in the flywheel; or, the gravity transforming device includes a flywheel; or, the gravitational potential energy of the circumferential body is output through a flywheel;

Or, wherein a driving device is provided to drive the circumferential body to create gravitational potential energy, and the gravity of the circumferential body acts on pressure sensitive material or a pressure sensitive device; or a gravity transforming device is provided to transform the gravitational potential energy of the circumferential body; said gravity transforming device is the pressure sensitive material or the pressure sensitive device; or, said pressure sensitive material includes pressure sensitive ceramic, or pressure sensitive silicone, or pressure sensitive biological membrane or pressure sensitive composite membrane; said pressure sensitive device includes the public-known devices that produces electrical currents or movement after they are pressed; said pressure sensitive material or pressure sensitive device could produces electrical currents or movement after they are pressed; said pressed includes impulse-type pressed, intermittent-type pressed, impact-type pressed, continuous pressed or rolling pressed; said pulse-type and intermittence indicate their literal meanings to public knowledge; said impact-type pressed means that a circumferential body with a certain speed impacts a pressure sensitive material or pressure sensitive device; said continuous pressed means that gravity of a circumferential body acts on pressure sensitive material or a pressure sensitive device for a certain time of duration, said duration is no less than 30 seconds; said rolling pressed means that a circumferential body rolls on pressure sensitive material or a pressure sensitive device;

Or wherein a driving device is provided to drive the circumferential body to establish the gravitational potential energy, and a gravity transforming device is provided to transmit the gravitational potential energy of the circumferential body to a gear box of an oil pumping unit or a belt pulley or a gear or a pull rod; said gear box or belt pulley or gear or pull rod indicates components incorporated into the oil pumping unit for power transmission;

Or wherein a stand column 7 of a circumferential body 6 is movably connected to a fixed pivot 8, or the stand column 7 of the circumferential body 6 is putted into a socket, and a driving device is provided to drive the circumferential body 6 to swing, and the driving device of the circumferential body 6 includes an electric motor 11, an eccentric wheel 12 and a lever 13, thereof the electric motor 11 is fixed on a door frame 10 mounted on both sides or periphery of the circumferential body 6, the left end of the lever 13 is connected to the eccentric wheel, and its right end movably connected to the stand column 7, while during operation, the eccentric wheel of the electric motor drives the lever 13, and the lever 13 drives the stand column 7 to swing the circumferential body back and forth, a transmitting rod 9 is provided to connected to the circumferential body 6, and the transmitting rod 9 moves up and down with swinging of the circumferential body 6 to transmit the gravity of the circumferential body 6 out; said gravity transforming device comprises an eccentric wheel or a crank that transforms the up-and-down reciprocation of the transmitting rod 9 into rotary motion; or the gravity transforming device includes a magnet connected to the transmitting rod 9, during operation, this magnet generates electricity by moving through the magnetic field lines of a solenoid.

or wherein a driving device is provided to drive the circumferential body to establish the gravitational potential energy, in the gravitational potential energy zone of the circumferential body, there is a protruding stud, through which, for both receiving gravitational potential energy of the circumferential body and distributing out the gravity energy of the circumferential body;

Or wherein, on a bearing surface 3, there is a cylinder-shaped circumferential body 1, upon which circumferential body gear 18 is attached, and above circumferential body 1, there is a driving device equipped with a driving gear 16 meshing with the circumferential body gear 18, and in the gravitational potential energy zone of the circumferential body 1, there is a gravity output device with a receiving gear 19, which in the potential energy zone of the circumferential body is meshed with the circumferential body gear 18, and the driving gear 16 drives the circumferential body gear 18, and the circumferential body 1 together with the receiving gear 19 rotates therewith, and the receiving gear 19 drives a generator or a gear box or machinery with power to output the gravity of the circumferential body 1, transforming it into utilizable power; the main body of the receiving gear 19 is mounted beneath the bearing surface, and partial of it are exposed above the bearing surface 3 for meshing with the circumferential body gear 18 and receiving transmission of the circumferential body gear 18, and the receiving gear 19 could also be changed into a friction wheel for friction transmission or a gear and an aperture wheel for tooth-aperture transmission; said tooth-aperture transmission is similar to a structure in which a gear drives a film in a film projector or a camera, whereas the present invention differs in that the tooth and the aperture could be located on the wheel or on a flat plate; as friction transmission is applied, the driving gear 16, the circumferential body gear 18 and the receiving gear 19 could be changed into the friction wheel;

Or, wherein the receiving gear 19 is supplied with power, and is driven by this power during operation, and the circumferential body 1 on the receiving gear 19 rotates therewith, transmitting its gravity to the receiving gear 19, hereby the receiving gear 19 is able to obtain more energy than the driving power; in order to transmit the gravity of circumferential body 1, one or more propping wheels aligned with the same axle of or its direction of the receiving gear 19, could be provided to push against the circumferential body 1 and withstand its weight;

Or wherein a driving device of the circumferential body is mounted above the circumferential body, and a receiving rod 26 is mounted beneath the circumferential body, the receiving rod 26 has a pivot 27 of a lever, and one end of the receiving rod 26 is interacting to the gravity transmitting point on the circumferential body to move up and down as the circumferential body rolls back and forth, and the other end of the receiving rod 26 has a gear or friction gear or an aperture wheel to output the gravity of the circumferential body, transforming it into utilizable power;

Or wherein a circumferential body gear 18 is provided on both ends of the circumferential body, also in the middle of the circumferential body, a touch-down gear 24 is provided with its diameter longer or shorter than or equal to the diameter of the circumferential body 1, the touch-down gear 24 locates on the bearing point gear 23, which undertakes weight of the circumferential body; the structures of the touch-down gear and the bearing point gear could be changed to the structure of slide surface or slide surface, that is, the slide surface of the circumferential body rolls on the bearing; the circumferential body gear 18 could simultaneously drive two receiving devices to output gravity;

Or wherein a driving device is provided to drive the circumferential body to establish the gravitational potential energy, and a gravity transforming device is provided to transform the gravitational potential energy of the circumferential body into utilizable power, said power is used to generate electricity, or to drive vehicles or drive energy-consuming equipment, and said vehicles include automobile, vessels, trains, airplanes and satellites.

2. Wherein the force to drive the circumferential body is less than the gravity outputted by the circumferential body;

or wherein said circumferential body is a sphere, a cylinder and a non-circular body, including a rolling or rotating or swinging or shaking object; the non-circular body includes an object with a circular arc-shaped bottom surface or an object in shaking or swinging or swaying manner; said circumferential body could be of multi-functions as a barn or coal yard or storeroom; a house or a barn or a good yard as such could be a circumferential body or a portion of the circumferential body; weight or volume of the circumferential body could be determined as required; the circumferential body could has a protruding structure 5; Said circumferential body is an object having a gravity surface; the circumferential body is of solid with gravitational potential energy of an attitude; the circumferential body could be made of one or combination of such materials as metal, plastic, stone, mud, resin material and concrete and so on; said circumferential body could be solid or hollow; or the hollow circumferential body has a plurality of cells therein, in which movable liquid or sphere or cylinder that serves as balance weight is provided; a house, an ore, a barn, a vehicle and a liquid each could serve as a portion of the circumferential body; the inner space of the circumferential body could accommodate human beings or animals; or, the circumferential body is comprised of two portions or a plurality of portions; or the circumferential body, in alignment of its axial direction, is divided into a plurality of segments, which are connected in series; or there are centering wheels in the periphery of the circumferential body, the centering wheels could be elastic; or said centering wheel is elastic;

Or one or more propping wheels in the same axle of the receiving gear 19 or its axle direction could be fixed; or the circumferential body is seated upon the bearing base; the bearing base means the base to support the circumferential body and its associated equipment or facilities, and it is composed of one or combination of the materials including metal, plastics, stone, mud, resin material, concrete and so on;

Or said bearing base could be a track or a rigid table board; or said door frame 10 mounted nearby the circumferential body has two or more stand columns flanking on both sides or at periphery of the circumferential body, there is a beam connected to stand columns thereupon, so that the door frame could be in a “Π” shape or a frame shape, and the door frame could be replaced with walls and roof of a building or house nearby the circumferential body, the door frame 10 provides basic conditions for mounting or moving the circumferential body or its associated machinery or equipment, and the door frame 10 could be composed of one or combination of materials including metal, plastic, stone, mud, resin, concrete and so on;

Or said circumferential body is equipped with a position-limiting device or a position-return device, said position-return device could be a return spring or a return pile or a return wheel or a return edge; the velocity of the circumferential body's motion could be set as required; Or, wherein said driving device includes a power device and a transmission device; said power device includes an electric motor or a combustion engine or man power or animal power or wind power or water power or magnetic force; said transmission device includes gear transmission device or rack-and-pinion transmission device or belt drive device or friction drive device or cam drive device;

Or, wherein said protruding stud could be made of metal, which protrudes out of the bearing surface and interacts with gravity transmitting point on the circumferential body; the shape of the protruding stud could be pile-like or column-like or semicircular or triangular; the protruding stud could be equipped with a return spring, so that it could be pressed down or bounces up in accord with the circumferential body's rolling; or, reciprocating motion of the protruding stud, by means of an eccentric wheel device or an crankshaft device or an rack-and-pinion device, is turn into rotary motion, which drives an electric motor or a gear box or flywheel or machinery/equipment with power to transform the gravitational energy of the circumferential body into utilizable power; or, the protruding stud is connected to a magnet, which is driven by up-and-down reciprocating of the protruding stud to move through the magnetic field lines for generating electricity and transforming gravity of the circumferential body into utilizable power;

Or, in said gravity transforming method, the output of energy is greater than the input of energy; the protruding stud could be changed into a receiving wheel, a receiving plate, a receiving rod, a receiving lever or a receiving connecting rod; said receiving wheel could be gear, belt pulley, tooth-aperture wheel or friction wheel; said receiving plate is plate-like; said receiving rod is rod-like; said receiving lever is lever-like; said receiving connecting rod could be connected to the center of the circumferential body to drive the crankshaft; or, the protruding stud on the bearing surface of the circumferential body protrudes its height 0.5 mm or more; or the distance from the protruding stud to the vertical central line of the circumferential body is equal to or greater than 0.5 mm; or, wherein the protruding stud locates beneath the bearing surface of the circumferential body, and a corresponding protruding structure is provided on the circumferential body; said potential energy zone means the zone beneath the circumferential body;

Or, wherein said gravity output device includes a gravity transferring device and a gravity receiving device; said gravity transferring device includes a gravity transmitting point or a gravity transferring lever or a gravity transferring rod or a gravity transferring wheel; said gravity transferring lever is in the shape of lever, and could be suspended upon the circumferential body; said gravity transferring rod is in the shape of rod, and is connected to the circumferential body; there may be a plurality of transferring levers or rods, and accordingly there are a plurality of devices to receive the transmission; said gravity transferring wheel includes a gear or a pulley or a friction wheel or a chain wheel or tooth-aperture wheel; said gravity receiving device includes the gravity receiving lever or the gravity receiving protruding stud or the gravity receiving wheel; said gravity receiving wheel includes a gravity receiving gear or a gravity receiving friction wheel or a belt wheel or a gravity receiving chain wheel or a gravity receiving tooth-aperture wheel; said tooth-aperture wheel is a tooth-aperture wheel by tooth-aperture transmitting, and said gravity receiving wheel could be equipped with ratchet wheel device;

Or, wherein said gravity receiving device could be an eccentric wheel or a crank, which transforms the reciprocating motion of the transferring device into rotary motion to drive a generator or a gear box or a machinery/equipment with power; and the gravity receiving device could also be a magnet connected to a transferring rod; during operation, the magnet moves up and down, passing through magnetic field line of the solenoid; Or, wherein there are a plurality of circumferential bodies to operate simultaneously; or, a plurality of circumferential bodies are connected together and driven by one driving device; or, said gravity transforming device could be mounted underground or semi-underground.

Advantages of the present invention: firstly, the present invention overcomes disadvantages of the prior art, and proposes and uses new scientific discovery, namely the Circumference Law; by using the “solid altitude gravitational potential energy” of the circumferential body, the present invention provides some gravity transforming methods and method of using circular motion to obtain gravity energy, as well as device and application thereof, creates condition to use gravity energy that is high in performance, low in cost, clean, cheap, safe and environment-friendly. If it succeeds, the gravity energy could be used to replace fossil energy resource, so as to help to recover global environment and ecology. Secondly, the present invention improves the efficiency of transforming gravity. Even if the first target cannot be realized, at least the present invention provides a method and device of using gravity to improve energy transforming efficiency, which helps or improves efficiency of using or transforming energy. Thirdly, the present invention provides more energy saving methods by using the circular motion theory. Fourthly, the present invention helps to reduce cost, including cost of obtaining and using energy. Fifthly, the method and device of the present invention could be used not only on transforming gravity, but also on saving energy and improving efficiency.

### BRIEF DESCRIPTION OF THE DRAWINGS

The following is the further explanation of the present invention in combination with the drawings and embodiments.

FIG. 1 is the structure diagram of the spherical or cylindrical circumferential body.

FIG. 2 is the structure diagram of the circumferential body in irregular shape.

FIG. 3 is the schematic diagram of the transforming device with fixed pivot.

FIG. 4 is the structure diagram of the circumferential body and the arc-shaped bearing surface.

FIG. 5 is the structure diagram of the gravity engine.

FIG. 6 is the structure diagram of the circumferential body and protruding stud.

FIG. 7 is the structure diagram of the FIG. 5 in A dir (direction).

FIG. 8 is the schematic diagram of the circumferential body with the circumferential body gear.

FIG. 9 is the schematic diagram of the lever transforming device.

FIG. 10 is the structure diagram of the inclined surface-connecting rod transforming device.

FIG. 11 is the structure diagram of the movable pulley transforming device.

FIG. 12 is the structure diagram of the inclined surface circumferential body device.

### DETAILED DESCRIPTION OF THE PREFERRED EMBODIMENT

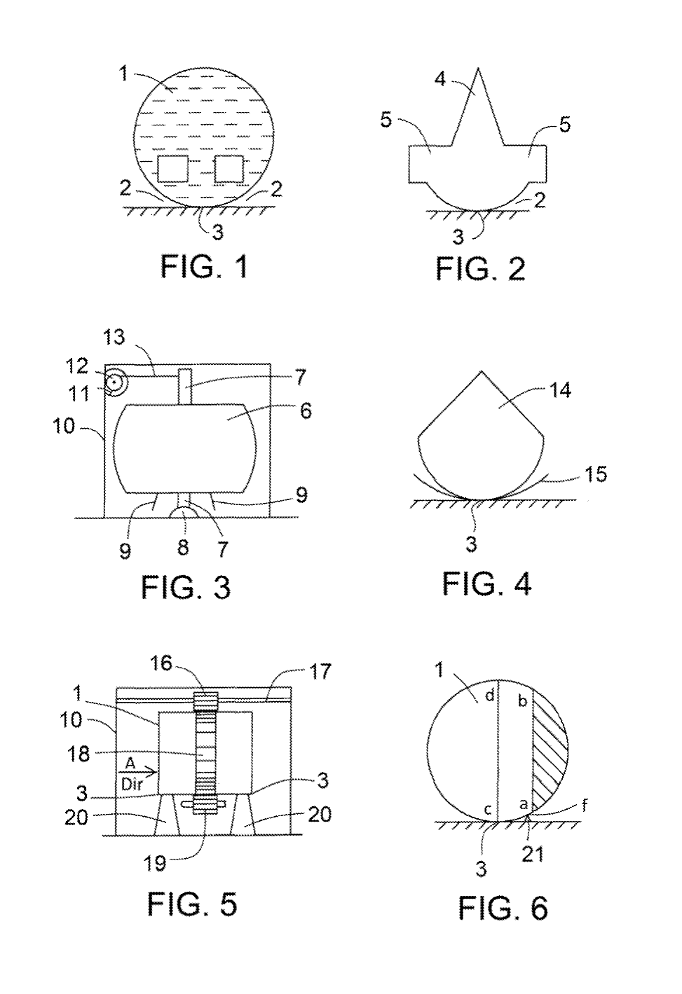

In FIG. 1, the spherical (or cylindrical) circumferential body is on the bearing surface 3. The circumferential body 1 has a potential energy zone 2 which means the space underneath the circumferential body. The noncontact area around the bearing point (also known as contacting point) of the spherical circumferential body is the potential energy zone, and area at both sides of the bearing point (contact line) of the cylindrical circumferential body is the potential energy zone. The receiving device could receive the gravity from the potential energy zone of the circumferential body, and could also receive the gravity on the circumferential body. The circumferential body 1 could roll less or more than 360 degrees of swinging amplitude. As shown in the figure, balance weight bodies like liquid and rectangle stones are filled in the circumferential body 1. And the circumferential body 1 could also be used as barn, coal yard and storehouse and is of multi-function. The volume or weight of the circumferential body 1 could be determined according to actual requirements. If conditions permit, the volume and weight of the circumferential body could be as big as possible. Because the bigger the volume and weight are, the gravity output is bigger and the effect is better. The circumferential body could be composed by one or combination of the materials including metal, plastics, stone, mud, resin, concrete and so on. And the circumferential body could be solid or hollow. Inner space of the hollow spherical circumferential body could be divided into cells in which movable liquid, sphere or cylinder is provided as balance weight. The liquid, sphere or cylinder could flow or roll along toward the rolling direction of the circumferential body, which enables the weights, namely the gravity of both side of the gravity surface difference, making the gravity that becomes driving power greater than the gravity that becomes resistance. Houses, ore, barn, vehicle, or liquid could be portion of the circumferential body. Inner space of the circumferential body could contain human beings, animals or cargos. In the actual application, even if it is impossible to reach the ideal condition as specified in the First Law of the Circumference Law, it is possible to approach the ideal condition and maintain the contact radius of the circumferential body constant and shape of bearing surface intact as much as possible. Besides, the difference between the ideal condition and the non-ideal condition is always small and could be ignored. For example, the “cutting watermelon” case as stated above, mass distribution of the watermelon is not uniform, and the surface-cutting of the watermelon maybe not right in the its middle, and each half segment of the watermelon weighs differently, but it still reflects and obeys the Circumference Law. The circumferential body means the bodies having the gravity surface and the solid altitude gravitational potential energy. All bodies having the solid altitude gravitational potential energy could be circumferential body. By using the gravity transforming device, the energy outputted by the circumferential body could be greater than the energy that is consumed by the circumferential body. The touch-down of the circumferential body means a point, a line or a plane thereon the circumferential body contacts with its bearing surface. At the non-ideal condition, the contacting point of the circumferential body is a plane. The more close to the ideal condition, the more the possibilities of a contacting point of the circumferential body becoming a point or a plane, and its effect is better. Said bearing point means a point, a line or a plane thereon the touch-down of the circumferential body contacts with its bearing surface. The bearing surface of a circumferential body is the surface of its base to undertake load, which could also be ground, pavement or track surface, various vehicles could be processed to be the circumferential body itself or its parts. Said “base to undertake load ” means the base to undertake the circumferential body or its associated equipment or facilities, said base is composed by one or combination of the materials including metal, plastics, stone, mud, resin, concrete and so on. The touch-down of the circumferential body could be processed, or its components could be manufactured ad hoc for durability of the touch-down and its flexible operation.

In FIG. 2, the irregularly shaped circumferential body 4 having arc-shaped bottom surface is on the bearing surface 3. And both sides of the circumferential body 4 are provided with protruding structure 5, which is used to increase gravity to reduce the volume and expand its use. All circumferential bodies could be provided with the protruding structure 5, which could be in other shape or structure, for example, rectangle, roundness, ellipse, or irregular shape. Bottom surface of the circumferential body 4 could be a spherical surface or an arc-shaped surface. The other portion of circumferential body above the bottom surface could also be in other shapes or structures, but this circumferential body cannot roll 360° as the circumferential body 1 shown in FIG. 1, only roll back and forth. Although it seems that the motion of the circumferential body 4 looks like swaying, in fact, it is still of roll because the circumferential body 4 could deviate from its original location of touch-down (namely the pivot) of undertaking its load, wherein, the bearing surface of the circumferential body 4 is located before motion. Any object's motion is of roll as long as its touch-down deviate from its original location. Swaying, swinging and shaking are motions, which retain their original location of undertaking its load.

In FIG. 3, a stand column 7 of the circumferential body 6 is in flexible connection with a fixed pivot 8. The circumferential body 6 has no arc-shaped bottom surface, so it could only sway. Once the circumferential body 6 moves, the centre of gravity becomes lower, and the radius curve of swaying also becomes lower gradually. With the centre of gravity becoming lower, the force required to drive it becomes greater. So the swaying amplitude should not be too large. The circumferential body 6 could also be in other shapes or structures like rectangle, round, triangle or profile modeling structure. The fixed pivot 8 could also be changed into socket, into which the lower end of the stand column 7 directly inserts. Swaying of the circumferential body 6 is different from rolling of the circumferential body 4, because the circumferential body 6 cannot deviate from its original touch-down but could only sway at this location. The circumferential body 6 could also have an arc-shaped bottom surface like the circumferential body 4, and its motion is a way of rolling back and forth at its original location. The driving device of the circumferential body 6 includes an electric motor 11, an eccentric wheel 12 and an input lever 13. The electric motor 11 is mounted on the door frame 10 that is mounted nearby the circumferential body 6. And the door frame 10 comprises two or more columns at both sides of or around the circumferential body 6. A beam is connected at the top of the column. The door frame could be in shape of Π or frame, and could be replaced by the wall and roof of building or house nearby the circumferential body. The door frame 10 provides basic condition for installation or motion of the circumferential body and associated machinery or equipment. The door frame 10 could be composed by one or combination of the materials including metal, plastics, stone, mud, resin, concrete and so on. The circumferential body 6 could be changed to the structures of the circumferential body 1 or of circumferential body 4, rolling on the bearing surface, while other structures of the circumferential body 6 remain the same.

The eccentric wheel 12 is mounted on the axle of the motor, and the eccentric wheel 12 could be replaced by crankshaft, and the effect will be the same. The left end of the input lever 13 is connected to the eccentric wheel, while its right end is in movable connection with the stand column 7. During operation, the eccentric wheel of the motor drives the input lever, and the input lever 13 drives the stand column 7 to sway the circumferential body 6 back and forth. The motor's rotary motion is changed into reciprocating motion of the circumferential body 6. Function of the driving device is to drive the circumferential body to move. The driving force could be electricity, elasticity, man power, animal power, wind power, water power, magnetic force or heating power. All prior arts related to driving could be used for the present invention.

The circumferential body 6 is provided with gravity output devices, said gravity output devices include transmitting rod 9 and a gravity receiving device. Two gravity transmitting rod 9 are provided in the potential energy zone of the circumferential body 6, and there could be a plurality of transmitting rod 9, which could be replaced with a lever that is matched with the crankshaft. The transmitting rod 9 is movably or fixedly connected to the circumferential body 6. When the circumferential body 6 sways, the transmitting rods move up and down. The transmitting rod 9 is connected to the gravity receiving device to transfer gravity of the circumferential body 6. The gravity receiving device could be an eccentric wheel or a crankshaft, which transforms up-and-down reciprocating motion of the transmitting rod 9 into rotary motion to drive generator or gear box or machinery or device using power. Therefore gravity energy of the circumferential body 6 could be distributed out. The transmitting rod 9 could be a magnet, during operation, the magnet moves up and down, moving through the magnetic field lines of the solenoid, so as to generate electricity. The transmitting rod 9 could also be a transmitting rack-and-pinion, wherein the lower end of the transmitting rod is a rack-and-pinion, the corresponding gravity receiving device is provided with a driven gear, which could also be equipped with ratchet gear, therefore, the driven gear receives the unidirectional transmission of the rack-and-pinion only. As the transmitting rack-and-pinion moves up and down each time, it transfers power to the driven gear. The transmitting rack-and-pinion could also be fixedly mounted on the circumferential body 6, but it is necessary to arrange relevant positions of the transmitting rack-and-pinion and driven gear according to swaying curve of the circumferential body 6. The input lever 13 could be omitted, thus the eccentric wheel or cam is used to drive directly the circumferential body 6 or stand column 7. A return device could be arranged at right side of the circumferential body 6, so that the circumferential body 6 could automatically return to its original location while swaying. The return device could be either an elastic device including spring or any circumferential body which sways or rolls on its original location. Since eccentric wheel or crankshaft or magnet moving through magnetic field line or rack-and-pinion transmission or spring belongs to public-domain technologies, it is hereby no need to explain more.

Anything that could sway, swing or shake is a circumferential bodies, the gravity thereof could be transformed by the method specified in FIG. 3.

In FIG. 4, the bearing surface 15 of the circumferential body 14 is arc-shaped, which could limit the position of the circumferential body 14. The circumferential body 14 could only roll on the arc-shaped bearing surface back and forth. The upper part circumferential body 14 is tapered, and its lower part is arc-shaped, the structure of the wind-blowing rock is the same as this. The circumferential body 14 could be provided with the driving device and gravity output device for the circumferential body 6 shown in FIG. 3. The circumferential body structure, the driving device, the return device and the gravity output device mentioned in the present invention are not limited to any certain embodiment, but could be exchanged according to actual condition and used in combination. For example, the driving device could be used for all circumferential bodies; and the circumferential body could be used in combination with any driving device or gravity output device. All technical features of the present invention are not limited to be used in any certain embodiment, and could be used separately or in combination. All related or same parts could be used in all embodiments. For example, all structures and technical features of the transmitting rod 9, the input lever 13 and receiving device could also be used to other embodiments or other aspects; therefore, the applicant hereby declares that it is unnecessary to repeat the same contents in every embodiment.

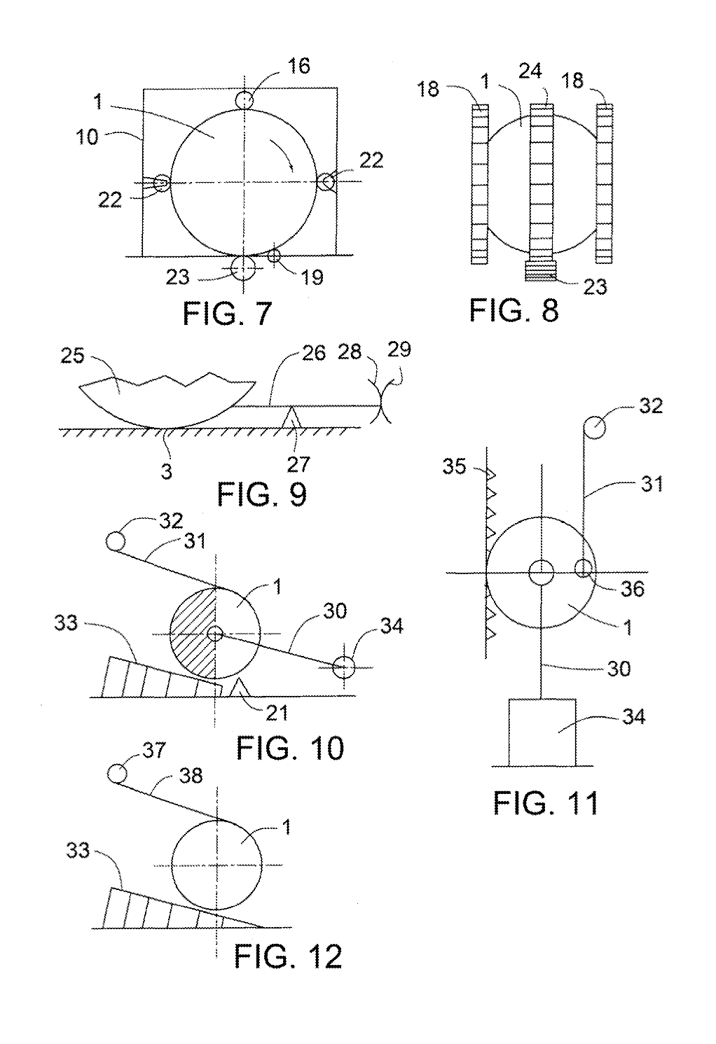

In FIG. 5, on a bearing surface 3, there is a cylinder-shaped circumferential body 1, upon which circumferential body gear 18 is attached, and above circumferential body 1, there is a driving device equipped with a driving gear 16 meshing with the circumferential body gear 18, and in the gravitational potential energy zone of the circumferential body 1, there is a gravity output device with a receiving gear 19, which in the potential energy zone of the circumferential body is meshed with the circumferential body gear 18, and the driving gear 16 drives the circumferential body gear 18, and the circumferential body 1 together with the receiving gear 19 rotates therewith. The main body of the receiving gear 19 is mounted beneath the bearing surface, and partial of it are exposed above the bearing surface 3 for meshing with the circumferential body gear 18 and receiving transmission of the circumferential body gear 18, the receiving gear 19 is evolved from the protruding stud. the receiving gear 19 drives a generator or a gear box or machinery with power to output the gravity of the circumferential body 1, transforming it into utilizable power. The receiving gear 19 could also be changed into a friction wheel for friction transmission or a gear and an aperture wheel for tooth-aperture transmission; said tooth-aperture transmission is similar to a structure in which a gear drives a film in a film projector or a camera, whereas the present invention differs in that the tooth and the aperture could be located on the wheel or on a flat plate; as friction transmission is applied, the driving gear 16, the circumferential body gear 18 and the receiving gear 19 could be changed into the friction wheel; Both ends of the circumferential body 1 are on the two abutments 20, which are made of one or combination of the materials including metal, plastics, stone, mud, resin, concrete and so on; the abutment is a kind of bearing base with a bearing surface for the circumferential body. The location of the bearing surface contacting with a touch-down of the circumferential body is the bearing point. The bearing surface of the abutments 20 could also be of arc-shaped as the bearing surface 15 shown in FIG. 4. For easy explaining, some portal frames as well limit wheel 22 and bearing wheel 23 are omitted in this Figure, they will be illustrated in FIG. 7. The circumferential body 1 could seat directly upon the bearing point, the bearing point could be also a bearing gear or a bearing pulley or a bearing sliding surface. There are also fitted with corresponding devices or structures upon the circumferential body. The circumferential body gear 18 could also be mounted at both ends of the circumferential body 1. The circumferential body gear 18 could also mesh with said bearing gear and is used as a touch-down gear, the contacting point of the circumferential body could have rigid surface, which moves on said bearing pulley or bearing sliding surface. The bearing surface could be a track surface or a rigid table surface. Lubricating oil could be applied to the bearing gear or bearing pulley or bearing sliding surface. The bearing position of the circumferential body 1 could be located at its middle. The diameter of the circumferential body gear 18 at the middle of the circumferential body 1 could be equal to, or more than, or less than that of the circumferential body 1, so as to design and use the circumferential body much easier. The driving gear 16 is connected to the gear axle 17. And there is a motor, omitted in this figure, mounted on the door frame 10 to drive the gear axle 17. The driving gear 16 could receive the motor's transmission through an intermediary wheel. The driving gear 16 could also be directly mounted on the shaft of the motor to drive the circumferential body gear 18, which could be manufactured and mounted according to prior art. For example, a big gear with same diameter as that of the circumferential body 1 could be casted and shaped together with the circumferential body 1, and prefabricated on the circumferential body 1. Or the circumferential body gear 18 could be divided into more segments for processing and installing upon the circumferential body 1. The diameter of the circumferential body gear 18 could be longer than that of the circumferential body for easy installation; and the circumferential body gear 18 could be fixed as long as inserting it into one end of the circumferential body. A plurality of circumferential body gears 18 could be provided on the circumferential body 1 to drive a plurality of receiving gears 19 at the same time. The circumferential body 1 and its associated machinery or equipment could be mounted underground or semi-underground, in case of people injured by accident of their rolling-down and save space. The diameter or rotary speed could be preset according to actual requirement. The speed of the circumferential body 1 and its associated machinery or equipment could be adjusted by employing different sizes of gears or gear boxes, the circumferential body 1, during operation, could continuously output its equivalent of the gravitational potential energy with solid altitude to the receiving gear 19. The present invention could be accomplished by the prior art.

In FIG. 6, the circumferential body 1 in shape of cylinder (or sphere) is provided on the bearing surface 3, and a driving device is provided to drive the circumferential body 1 rolling back and forth. One driving device could be used to drive a plurality of circumferential body rolling at the same time. A protruding stud 21 is provided to receive gravity in the energy zone of the circumferential body 1, and the protruding stud 21 exposes out of the bearing surface 3; the protruding stud 21 is made of metal in the shape of pile, or column, or semi-circle or triangle, which is interacting with the transmitting point on the circumferential body 1. The transmitting point could be a socket, which helps to transmit the force accurately. The transmitting point or protruding stud could be of rigid surface to reduce or prevent abrasion. The protruding stud 21 could be equipped with a return spring, so that it could be pressed down or bounces up in accord with the circumferential body's rolling; The up-and-down motion of the protruding stud 21 could be transformed into rotary motion through the eccentric wheel device, the crankshaft device or the rack-and-pinion device, so as to drive motor, gear box, flywheel, pressure sensitive device or machinery using power to run, thus the gravity of the circumferential body 1 is output and transformed into utilizable power. Or, the protruding stud 21 is provided with a magnet, which is driven by up-and-down reciprocating of the protruding stud 21 to move through the magnetic field lines for generating electricity. Neither structure nor technical approach in FIG. 6 is different from that in FIG. 5. If gear transmission structure in FIG. 5 is applied, the protruding stud is unnecessary.

FIG. 6 could explain the location interrelation between the circumferential body and the protruding stud. In the Figure, a straight line cf is drawn from the fixed pivot of the circumferential body 1 (namely the bearing point of the bearing surface 3) to the protruding stud 21. We could see that the circumferential body 1 is equivalently on the inclined-plane (namely the straight line cf), as the driving device drives the circumferential body 1 to move towards the right, and close to climbing onto the protruding stud 21. The pivot of the circumferential body 1 shifts to the protruding stud 21, as soon as the circumferential body 1 deviate from the bearing surface 3, during the circumferential body 1 is driven by the driving device to move towards the right. The extended line (ab line) connecting from the protruding stud 21 to the geocenter is the gravity surface of the circumferential body 1. At this moment, the gravity direction at the right of the gravity surface (dash area) is towards the right, which has the upward potential energy, is the driving force given to the circumferential body 1 to move upwards and climb onto the protruding stud 21. It is the gravity in the dash area plus the driving force from the driving device that drive the circumferential body 1 to climb onto the protruding stud 21. The gravity in the dash area is the very residual energy said in the present invention. As long as the idle work in the entire gravity transforming device loses less than the gravity of the dash area, the residual energy could be generated. Therefore, the closer the protruding stud 21 to the vertical central line (cd line) of the circumferential body 1, namely the bigger the dash area, the greater the residual energy. Said vertical central line means the central line on the circumferential body is perpendicular to the horizontal line. The protruding stud to the vertical central line of the circumferential body distance more than 1 mm. The height of the protruding stud 21 could be either power strokes by the circumferential body outputting gravity, or strokes by the connecting rod and crankshaft. During the process of the circumferential body 1 climbing onto the protruding stud 21, the circumferential body 1 is pushed by the driving force from the right side. With the driving force increasing, the circumferential body 1 deviates from the bearing surface 3, gradually increasing pressures to the protruding stud 21 until the entire gravity (weight) is transferred to the protruding stud 21. The protruding stud could be mounted on the circumferential body 1 to transmit the driving force into the internal circumferential body 1, wherein the corresponding receiving device is provided. Such kind of circumferential body with “a structure of an inward protruding stud” could be used for movable products like vehicle.

If we take the circumferential body 1 in FIG. 6 as a watermelon, and cut it at ab line, the watermelon at right side of ab line, namely the dash area will fall down to the inclined-plane upward, because the watermelon at right side of ab line has altitude gravitational potential energy upward. This experiment proves that “no matter the circumferential body on the inclined-plane either ascends or descends, its gravity surface is always on the extended line connecting the pivot to geocenter, and “the gravities at both sides of the gravity surface are opposite in direction,” and “there are always some of gravities becoming a driving force”. And the experiment could also prove that “As long as the protruding stud is in the potential energy zone of the circumferential body, there are gravities that could be transformed into driving forces. As long as the force to drive the circumferential body pressing down or climbing onto the protruding stud is less than the gravities of the circumferential body, there will be gravities to be output. As long as the resistance due to an attitude of the protruding stud, namely the driving force required to drive the circumferential body, is less than the gravities of the circumferential body, the energies output more than the energies being input”. This is the fact and theoretical basis of the present invention.

If the protruding stud 21 is installed on the bottom of the “wind-blowing rock”, we could use the wind to generate electricity.

In FIG. 7, for easy explaining, A-direction door frame and abutment 20 are omitted. The driving gear 16 is provided on the circumferential body 1, and the bearing wheel 23 under the circumferential body 1, and either of limit wheel 22 separately at left and right side. There is a receiving gear 19 below on the right side of the potential energy zone's bottom. Under such structure without the receiving gear 19, in theory, the force from the driving gear 16 to drive the circumferential body 1 needs only more than zero .In order to obtain as much the gravitational potential energy and the efficiency of gravity-transforming as possible, the vertical central line of the receiving gear 19 is very close to that of the circumferential body 1. The closer the receiving gear 19 to the vertical central line of the circumferential body 1, the less the force required to drive the circumferential body 1, and the more the gravity of the circumferential body 1 obtained. In FIG. 7, the driving gear 16 meshes with the circumferential body gear to drive the circumferential body 1 turning toward the right. The circumferential body gear drives the receiving gear 19, which is meshed with the gear of the motor or gear box or machinery or equipment using power, distributing out the gravitational potential energy of the circumferential body 1. The limit wheel 22 as limiting for the position of circumferential body 1 could be a bearing, or a gear, or a pulley or a sliding surface. The plane of limit wheel 22 could be not aligned with that of the circumferential body gear, the limit wheel 22 could be elastic, keeping a certain distance away the circumferential body 1 for its easy movement toward the right and exerting force. The driving gear 16 could also be elastic or meshed loosely with circumferential body for its easy movement toward the right and exerting force. There are two bearing wheels 23 flanked axially under the circumferential body 1. The main body of the bearing wheel 23 is under the bearing surface 3, only the gear portion thereof expose out of the bearing surface for meshing with the circumferential body gear. There could be a plurality of bearing wheels 23 to distribute pressure. The gear and pulley need equipping with bearing for their flexible running. The bearing wheel 23 could be a pulley or a sliding surface. The pulley has no shaft and is able to undertake the huge gravity of the circumferential body. The load capacity of the sliding surface is even bigger. The sliding surface is the very sliding surface of the circumferential body, which matches with that of the bearing surface, between these two sliding surfaces are lubricating oils.

hypothesis: the driving force of the driving gear 16 (namely the driving gear 16) is 400 kg, the circumferential body 1 weigh 1200 kg, and its diameter is 3600 mm, the receiving wheel 19 (namely the receiving gear 19) is 12 mm of height (namely the protruding height out of the bearing surface) Because the diameter of the driving gear is identical with that of the receiving gear, so do their rotary velocities and strokes, and thereby it will give rise to no problem deriving from different strokes. As soon as the driving gear 16 moves, the receiving wheel 19 could immediately obtain the gravity of 1200 kg, producing residual energies of 800 kg. The double of the energies is obtained compared with the energies consumed. Refer to the experiment excerpt of 4.1 “rolling cylinder onto the wood board” on the present invention's descriptions or relating contents on FIG. 6, the receiving wheel 19 is changed from the “wood board” or “protruding stud 21”. If height (namely the vertical central line of the receiving wheel 19 close to circumferential body) of the receiving wheel 19 (namely protruding stud) is reduced, the driving force could be greatly reduced. If the weight of the circumferential body 1 is increased, the obtained residual energy could be increased greatly. If height of the receiving wheel 19 is reduced, at the same time, the weight of the circumferential body 1 is increased, the energy consumed will be much less than the energy obtained.

On the same axle or axial direction of the receiving gear 19 is one or more propping wheels, which serve for pushing against the circumferential body 1, and for withstanding the weight of the circumferential body 1, which also for controlling the gap between the circumferential body gear and the receiving gear in case of the circumferential body 1 crushing the receiving gear 19, or in case of the circumferential body 1 and the receiving gear 19 getting stuck each other with negative influence upon their rotation. The propping wheel could also serve as friction transmission, aiding the receiving wheel to transfer the gravity of the circumferential body out.

In FIG. 7, a driving device could be removed, namely no driving gear 16. The receiving gear 19 is driven by directly. During operation, the receiving gear 19 is received a driving force, on the receiving gear 19, the circumferential body 1 rotates therewith, transmitting the gravity to the receiving gear 19, which enable the receiving gear 19 to obtain extra gravity energies other than the driving force itself. The gravity transforming device in the present invention could become a gravity engine.

The efficiency could be improved by increasing speed and reducing the hours of energy utilizing. For example, when a chain hoist (namely manual crane) or a movable pulley (including movable pulley block) is used to lift a heavy object, the energy could be saved by increasing speed and reducing the hours of energy utilizing. For example, the oil pumping unit is unable to stroke more frequently, as it is limited by the flowing condition of petroleum underground on oil fields, which in turn limits the frequency of stroke-the number of the oil pumping lever stroking up-down during unit interval. However, the rotary speed of the motor could be chosen. The present invention employs a low-powered motor with high-speed, by means of “energy=force×velocity-that is “to increase speed” to save energy for the oil pumping unit. For example, an oil pumping unit is matched by a motor of 60 kw; it rotates 800 rpm and strokes one time per minute, and is capable of lifting the weight of 3 tons each time. For a motor of 60 kw, it is impossible and unnecessary to save energy by increasing rotary speed, which would exceed the frequency of stroke. A motor of 20 kw with high-speed of 2400 rpm could be used in the present invention, which first drives the “gravity transforming device” in the present invention, by means of the “gravity transforming device” in return, further drives the original device of the oil pumping unit. The “gravity transforming device” as shown in FIG. 5 and FIG. 7 could be used. The receiving gear 19 transmits the received driving force to a gear box or a power wheel or a pull rod of the oil pumping unit, driving the oil pumping unit operation. The gear box, the power wheel and the pull rod are all components or devices in the oil pumping unit for receiving power. In this way, a motor of 20 kw could perform the task, which needs a motor of 60 kw; more than 50% of the energy is saved. The frequency of stroke is still one time per minute, lifting the weight of remains 3 tons each time, yet the energy consumption is reduced successfully. It is possible to change a motor with 60 kw directly into a high-speed motor with 20 kw? It is impossible to lift the overweight, unless a “power-saving device” is added; although this power-saving device could also be a gear box, which could only alter speeds, but neither uses the gravity nor save energy, its efficiency much lower than the present invention. The present invention could save the power of a motor by means of the gravity of the circumferential body.

In FIG. 8, in the middle of the circumferential body is a touch-down gear 24 with its diameter longer than the diameter of the circumferential body 1. its diameter could be also longer than or equal to or shorter than the diameter of the circumferential body 1, in order to design and use more easily. The touch-down gear locates on the bearing point gear 23, bearing point gear 23 withstands weight of the circumferential body. the structures of the touch-down gear and the bearing point gear could be changed to the structure of slide surface or slide surface, that is, the slide surface of the circumferential body slide on the bearing surface of the circumferential body; or the structure could be changed to structure of sliding surface and bearing, namely the sliding surface of the circumferential body rolls on the bearing. Both ends of the spherical circumferential body are connected with the circumferential body gear 18, which could simultaneously drive two receiving devices to output gravity; The circumferential body 1 could also be changed from a sphere into a cylinder, the touch-down gear 24 at the middle and the circumferential body gear 18 at both ends remain unchanged, so does the transmission means. The circumferential bodies in FIG. 7 and FIG. 8 could roll or rotate, which has advantages as follows: firstly, it is not restricted by stroke and easy for power-transmitting and interacting; secondly, the receiving wheel could maximally close to the vertical central line of the circumferential body, the gravity of the circumferential body could be obtained to its maximum; thirdly, it is a simple structure with less space occupied; fourthly, it transmits force accurately with high-efficiency; fifthly, it is robust and durable and low-cost.

In the present invention, a plurality of driving gears could be mounted on one shaft, and only one motor is employed to drive a plurality of circumferential bodies at the same time.

In FIG. 9, the circumferential body 25 is only one portion of a sphere or a cylinder, there are some omitted in this figure. The driving device of the present invention could be used to drive the circumferential body 25. In the potential energy zone of the circumferential body 25 is a receiving rod 26 with a pivot 27; the left end of the receiving rod 26 is interacting with the transmitting point on the circumferential body 25 to receive the driving force from the circumferential body 25. At the right end of the receiving rod 26 is a driving gear 28 meshed with a driven gear 29 to transmit power. If it is an equal-arm lever (namely the length of the resisting arm is identical with that of the power arm), it will lift up same weights, and its principle is the same as “balance scales”, which indicates that the gravity transforming efficiency could be up to 100%.

FIG. 10 is a kind of “circumferential body device on an inclined-plane”. on the inclined-plane 33 is a circumferential body 1 equipped with an input connecting rod 31 and a driving device 32. The input connecting rod 31 transmits the driving force from the driving device to the circumferential body 1, rolling it back and forth. At the circle center of the circumferential body 1 is mounted an output connecting rod 30, which drives the crankshaft of the receiving device 34 to rotate, outputting the gravity of the circumferential body 1. The angle of the inclined-plane 33 in the Figure (i.e. angle between the inclined-plane and the horizontal plane) could be about 25°. The angle between the inclined-plane 33 and the horizontal plane could be a range of 90°-180°, i.e. the angle between the horizontal to the vertical. The distance of the circumferential body 1 rolling over on the inclined-plane is the stroke of the crank or the connecting rod, and the stroke could be determined according to actual requirement. Said input connecting rod could be flexible ones, which includes flexible material or device, such as soft rope, soft belt, soft cord, steel cable, nylon rope, leather belt, plastic rope, as well as bicycle-chain, anchor-chain and so on. Said input connecting rod 31 and output connecting rod 30 could be rigid ones, which includes rigid material or device, such as connecting rod of combustion engine or steam train or treading-type sewing machine. The rigid connecting rod could connect to the circumferential body 1 moveably or flexibly, the flexibly connecting means the location where the rigid connecting rod connecting to the circumferential body is transformable. The stroke of the rigid connecting rod is matched with the stroke of the output connecting rod 30 or protruding stud 21. The rigid connecting rod can, by means of the idle turning of the driving device 32, transmit the driving force of the driving device 32 together with the gravity of the circumferential body 1 to the receiving device 34 during the circumferential body 1 moving downwards. For example, the gravity of the circumferential body 1 is 1200 kg, and the driving force of the driving device 32 is 400 kg; as the circumferential body moves downwards, the crankshaft will obtain a driving force of 1600 kg. According to actual requirement, the diameter, the weight and the strokes of the circumferential body 1 could be adjusted, so do the angle of inclined-plane and the magnitude of the driving force. The driving device 32 could be provided with an eccentric wheel, a cam or a crankshaft connecting to the input connecting rod 31. The protruding stud 20 is provided below the circumferential body 1, which could simultaneously do work to both the output connecting rod 30 and the protruding stud 21, or to only one of both. The protruding stud 21 could be equipped with return spring to replace the output connecting rod 31, so as to rotate the crankshaft under the protruding stud 21. The receiving device 34 could be provided with such a flywheel as that of the combust engine. The output connecting rod 30 could also be changed into an output thrust rod rotating the flywheel. On the output thrust rod, there could be provided with a ratchet gear, whereas the flywheel is accordingly provided with steps or groove or structure or device, the ratchet gear rotates the flywheel. This structure could be identical with the chain-ratchet device of a bicycle within public domain. The dash area at the left of the circumferential body 1 represents its weight on the left side is greater than the weight on its right side. Because the circumferential body 1 reciprocates, when it moves upwards, the weight at its left side always becomes a force to drive, in this way, the driving force could be reduced; whereas the circumferential body 1 moves downwards, the whole weight remain unchanged, and the gravity obtained is still same. The driving device could directly or indirectly transmit the circumferential body. For example, as shown in FIG. 10 or FIG. 11, a movable pulley (said movable pulley includes movable pulley block) could be used in the driving device, the traction force (i.e. driving force), via the movable pulley, transmits the power to the input connecting rod All traction of the present invention could be employed such structure. It is public-knowledge that rolling cylinder on an inclined-plane could save more than half of the force. The Circumference Law believes the gravitational potential energy of a solid circumferential body with certain attitude could be converted unlimitedly. As long as the circumferential body 1 is repeatedly being pulled up and pushed down (or being dropped down), which could drive the receiving device 34 and/or protruding stud 21 to work, and the gravity energy will be endlessly outputted. A large amount of energy could be obtained by duplicating such gravity transforming device in mass production. Assuming the circumferential body 1 weighs 1200 kg, its diameter is 3 meters, the inclined-plane 33 leans an angle of 25°. According to the experiment, the traction force (i.e. the driving force) to drive the driving device requires approximately 400 kg. At least 1200 kg gravity could be obtained by using only 400 kg traction force; the gain substantially surpasses the loss. The 1200 kg gravity output could be obtained each time, by continuously rolling the circumferential body 1 back and forth with a driving force of 400 kg,

There are similarities between FIG. 11 and FIG. 10. The circumferential body in FIG. 10 moves along an inclined-plane, while the circumferential body in FIG. 11 makes up-and-down movement upon a rack-and-pinion 35. There is the rack-and-pinion 35 on the left of the circumferential body 1, on which or the local of which is a corresponding gear. This gear is movably matched with the rack 35, moving the circumferential body 1 up and down along the rack 35. The circumferential body 1 has the features of a movable pulley. Half of the traction force to pull the circumferential body 1 upwards could be saved. The circumferential body 1 is provided with an eccentric shaft 36 connected to the input connecting rod 31, which is connected to a driving device 32, the driving device 32, through the input connecting rod 31, lifts up or pushes (or drops) down the circumferential body 1. Diameter and weight of the circumferential body 1 could be determined according to actual requirement. To the circle center of the circumferential body 1 connects an output connecting rod 30, which is connected to a receiving device 34. The output of the gravity of the circumferential body 1 could be gained by continuously lifting up and pushing (or dropping) down the circumferential body 1.

For example, weight of the circumferential body 1 is 1200 kg, and the driving force needs only 600 kg, with a remaining gravity of 600 kg to be transformed. Instead of the rack-and-pinion 35, steel wire rope could be used to drag the circumferential body 1. However, the “idle driving force” as in FIG. 10 cannot be used. The circumferential body 1 could also be a public-known moveable pulley, below which is hooked with a heavy weight connected to the output connecting rod. The circumferential body 1 could also flexibly connect to its or carrier at the left side, in this way, it turns into a circumferential body swinging up and down. If volume of the circumferential body is big enough, it could swing with amplitude in accordance with the stroke for the output connecting rod (the output connecting rod could be crank connecting rod device).

The circular constant could be used for respectively calculating the strokes of the input connecting rod 31 and that of the output connecting rod 30, i.e. the stroke (perimeter) of the input connecting rod 31 is 3.14 times the stroke (diameter) of the output connecting rod 30. However, the strokes of the structure shown in FIG. 10 are unable calculated entirely according to the circular constant, because they are not or all not relation between perimeter and diameter.

FIG. 12 is a kind of “inclined-plane circumferential body” device, which could be used as a carrying tool. Over the circumferential body 1 is a traction device, which includes a motor 37 and a steel rope 38. For example, a “cylinder-shaped trolley” could be used to carry ore or slag on the mine or undermine. This method is to make the circumferential body 1 into a hollow cylinder with lids, the ore or slag could be put inside of the circumferential body 1. The traction device is employed to roll the circumferential body 1 upwards, with an outcome of more than half of the energy saving. As the ore or slag is collision-resistant, they could be filled into the circumferential body 1, with which roll upwards. After the circumferential body 1 is moved to the destination and its lid off, the ore or slag is unloaded. Once again the circumferential body 1 is dropped down for reloading. The “cylinder-shaped trolley” could also be used in wharf or goods yard, a track or rigid road surface could be provided on the inclined-plane.

A flywheel could compensate and adjust power and velocity, accumulating energy for machinery in stable operation. A flywheel is a circumferential body too, regardless of its mass, the force to overcome its stationary inertia exceeds the friction of its bearing, and the force to overcome its motion inertia exceeds the external force applied to it. A gravity transforming device could connect to a flywheel. For example, all transmitting rod 9, protruding stud 21, and receiving wheel 19 could initially transmit their power to the flywheel, through which, in turn the energy is distributed out. Said flywheel could be a big flywheel with heavy weight and huge volume, which could weigh more than 500 kg, also the big flywheel could be made by one or combination of metal, concrete, plastics and stone.

Said gravity energy in the present invention includes the gravity energy on other planets as well as employing the present invention on other planets

The present invention could be used for generating electricity or transport tool or various needs for producing and living. Said vehicle includes automobile, ship, train, airplane, and man-made satellite. The present invention could make a contribution to energy-saving and pollution-cutting plan.

The following is further explanation of the present invention.

1. The focus is that whether the Circumference Law is true and whether there is fact to deny the Circumference Law.

Firstly, the inventor provides many facts that could prove that the Circumference Law is an objective law. The technician of this field could totally understand the Circumference Law with the specification and the figures, especially the First Law of the Circumference Law, because this law is a simple basic law, and the fact is very clear.

Secondly, under a condition that the Circumference Law, proved by substantial facts, is an objective law, it should not employ the theory which is denied by the facts presented in the Circumference Law and is against the Circumference Law to verify or deny the Circumference Law. To deny the Circumference Law, there must be facts to prove that the Circumference Law is incorrect. Apparently the method of using theory to test or deny the theory is not suitable. Since disclosure of the Circumference Law, none of the adverse opinions could give corresponding fact.

For example, to deny the core theory that “the gravity at the both sides of the gravity surface is identical in strength but opposite in direction, and the force to overcome stationary inertia force is greater than zero” as stated in the First Law of the Circumference Law, there must be fact to prove that this phenomenon does not exist.

Thirdly, it is incorrect to arbitrarily conclude that the Circumference Law disobeys the existing laws without considering the fact as stated in the present invention.

The existing theory cannot be used to test and deny the present invention, and it is incorrect to arbitrarily conclude that the Circumference Law disobeys the existing laws without considering the fact as stated in the present invention. Before there are enough facts and reasons to deny the Circumference Law and the gravity transforming device, the Circumference Law and the gravity transforming device are possibly correct and reasonable. If there is nothing to deny the Circumference Law, it is impossible to deny the gravity transforming method and device thereof. The gravity transforming device includes all devices that could transform gravity, including gravity generator and gravity vehicle.

2. The Circumference Law is opposite to the Newton's Laws of Motion, facts are indispensable to prove which is correct.

The inventor has provided enough facts and reasons to prove that, in the circular motion field, the Circumference Law complies with the objective law of circular motion, while the Newton's Laws of Motion do not comply with the objective law of circular motion. Although the Newton's Laws of Motion are truth tested by practice, all truths are relative, with a certain scope and limitations. Therefore, in the circular motion, the Newton's Laws of Motion may not be still the truth. Which is correct, Newton's Laws of Motion or the Circumference Law? Facts and practice are indispensable to prove the truth. At this situation, the legal status of the Circumference Law is equal to that of the Newton's Laws of Motion. It is just like the plaintiff and the defendant who have equality of status on civil court. We cannot determine the right and the wrong based on authority, or take part with any parties.

Therefore, in this application, we cannot say that “the Circumference Law disobeys the Newton's Laws of Motion and Law of Conservation of Energy”, and the Newton's Laws of Motion and Law of Conservation of Energy cannot be used to deny the Circumference Law. The existing theory cannot be used to test a new theory that is opposite to it; otherwise, it disobeys the equity principle, the principle of seeking truth from facts and the scientific spirit of human being of seeking truth.

We must admit that the science is developing and changing. The practice is the only standard to test the truth. Therefore, the Newton's Laws of Motion should also be developing and changing. When there are new facts and reasons that deny or revise the Newton's Laws of Motion, we should analyze and discuss it with principle that “the practice is the only standard to test the truth”.

3. To deny the Circumference Law, it is necessary to deny the facts like “cutting watermelon”. The science is on the basis of fact, and the following is the fact of “cutting watermelon” to prove that the Circumference is correct.

3.1 If a watermelon is cut from the middle vertically, the watermelon will definitely fall down to the two opposite sides in two pieces. Even if the two pieces are put together, they will fall down to the two opposite sides in two pieces again after loosening the grip. The reason of this phenomenon is included in the Circumference Law: because the watermelon is a spherical circumferential body, and all circumferential bodies obey the Circumference Law. By cutting it from the middle vertically, the cutting surface is the “gravity surface” of the watermelon. Because the two pieces of watermelon fall down to two opposite sides, it proves that the gravity of the two pieces of watermelon is opposite to each other. Of course the direction of gravity is downward; however, for the expression on the circumferential body, because of the structure, motion trends of the gravity at both sides of the gravity surface are opposite to each other. Even though the mass distribution of the watermelon is non-uniform, and perhaps the cutting position is not right in the middle, and the two pieces of the watermelon is possibly different in mass, but the fact of “cutting watermelon” expresses according to the Circumference Law, and still proves the Circumference Law.

3.2 The fact is objective and undeniable. This fact at least could prove that “the gravity of the two pieces of watermelon is opposite in direction”. Although direction of gravity is downward, because the watermelon is a circumferential body, the gravity potential energy of the two pieces is opposite to each other, so they will fall down to the opposite direction.

If we admit that “the two pieces of watermelon fall down to two opposite sides”, we have to admit that “the gravity direction of the two pieces of watermelon is opposite to each other”;

If we admit that “the gravity direction of the two pieces of watermelon is opposite to each other”, we have to admit that “the two pieces of watermelon is resistance or drive force of each other”;

If we admit that “the two pieces of watermelon is resistance or drive force of each other”, we have to admit that “the force to overcome the stationary inertia force is greater than zero”;

As a result, the First Law of the Circumference Law is proved by the fact.

After admitting that the First Law of the Circumference Law is an objective law, it is easy to understand the second to sixth laws of the Circumference Law. Because the First Law is the basis of the Circumference Law, the second to sixth laws of the Circumference Law are deduced from the First Law, and are extension and explanation to the First Law.

To deny the Circumference Law, it is mandatory to deny the First Law of the Circumference Law, because the First Law is the basis of the Circumference Law.

3.3 The following is analysis of the Second Law of the Circumference Law.

If we admit that “the force to overcome the stationary inertia force is greater than zero”, we have to admit that “the acceleration of the circumferential body after being stressed is irrelevant to the mass thereof”;

If we admit that “the acceleration of the circumferential body after being stressed is irrelevant to the mass thereof”, we have to admit that the formula f=ma is false, namely f≠ma, in which the “M” becomes a constant. The fact of “cutting watermelon” has proved that “no matter how big the mass of the circumferential body is, the force to overcome the stationary inertia force is greater than zero”.

As a result, the Second Law of the Circumference Law is proved by the fact. The Third to Sixth Laws of the Circumference Law could also be proved in the same manner. And the application document of the present invention has also explained, so it will not be covered again here.

3.4 The fact of “cutting watermelon”, as well as the facts of “roly-poly toy” and “wind-blowing rock”, is obvious factual evidence to prove that the Circumference Law is scientific and complies with objective law. The above facts not only prove that the Circumference Law is correct, but also prove that it is incorrect and unsuitable to apply the Newton's Laws of Motion in the circular motion. Therefore, the opinion that the present invention disobeys the Newton's Laws of Motion is wrong and inconsistent with the basic facts.

Apparently, to deny the Circumference Law, it is indispensable to deny the above facts including the fact of “cutting watermelon”.

4. The experiment of “rolling cylinder onto the wood board” could prove that the present invention could create “residual energy”.

4.1 The inventor has done an experiment of “rolling cylinder onto the wood board”. In order to help to explain the present invention, the experiment is hereby published. This experiment proves that the inventor saves energy and creates energy by using the gravity. The experiment includes the following: connect two ends of a piece of rope of about 6 meters in length together, and put the rope on the ground with two long sides about 10 cm away from each other in parallel. Put a wood board of about 12 mm in thickness on one end of the rope so the rope is pressed under the wood board and fixed. And put a 12 kg cylinder transversely on the rope (the cylinder used in the experiment was a 12 kg liquefied gas storage tank, diameter thereof is about 30 cm). Put the cylinder next to the wood board so the wood board is in the noncontact area under the cylinder, namely in the potential energy zone as stated in the present invention. Place the other end of the rope over the cylinder and connect the rope with a domestic spring scale of 6 kg scalar over the wood board. Pull the spring scale to roll the cylinder onto the wood board. In the experiment, the maximum traction force as shown on the spring scale is 4 kg, which means that the inventor drags a 12 kg cylinder (namely the circumferential body) onto a wood board of 12 mm in height by using a 4 kg force, and thus the 12 kg gravity is obtained. This experiment proves that the force to drive the circumferential body to roll onto the wood board is greatly less than the gravity. 12−4=8, so a force of 8 kg is saved. And the force of 8 kg is the “residual energy” as stated in the present invention. By repeating the above experiment, the “residual energy” of 8 kg could be obtained every time. If the cylinder in the above experiment is connected with the protruding stud as stated in the present invention, when the cylinder drops down, the gravity of 12 kg of the cylinder could be output by the protruding stud. For example, the gear is mounted on the cylinder, and the wood board is changed into corresponding driven gear, and then the cylinder drives the driven gear to rotate; as a result, the driven gear could obtain the driving force of 12 kg, which is three times of the consumed traction force of 4 kg. Refer to FIGS. 5 and 7.

The experiment of “rolling cylinder onto the wood board” itself could be the gravity transforming method and device. For example, the cylinder in the experiment is changed to a water container, then a force of 4 kg could be used to lift the water of 12 kg to a height of 12 mm, and all water inside could be drained off by taking off the cap, and then this process could be repeated. As a result, we could save force of 8 kg, and obtain the relative work, namely lifting the 12 kg water onto a height of 12 mm. This process could be repeated to lift the water till the water is lifted to a required height. The reason for this is that the circumferential body is established. The key point is to establish and roll the circumferential body, and only the circumferential body could be used to achieve this effect. The experiment of “rolling cylinder onto the wood board” is just a simplest gravity transforming device and has gap with the real gravity transforming device. This experiment is only to facilitate explanation and understanding, and it could completely be much better. The real gravity transforming device is more complex and effective. For example, various circumferential bodies could be used, and the diameter and weight of the circumferential body could be added, and height of the wood board could be reduced, so more “residual energy” could be obtained. Through massive production of this kind of gravity transforming device, endless energy could be obtained.

4.2 One question is that: why is the “residual energy” generated?

The solid altitude gravitational potential energy of the circumferential body already exists. Rolling the circumferential body could output the solid altitude gravitational potential energy of the circumferential body, which is also ingenerate. Therefore, the Circumference Law concludes that: rolling the circumferential body could create the solid altitude gravitational potential energy, and the rolling circumferential body stresses same gravity to every point or every line on the way. Rolling the circumferential body could obtain endless energy. The present invention resolves the following two problems: how to create potential energy and how to receive the potential energy. The force used to recover the potential energy of the circumferential body is much smaller than the gravity thereof, such that the potential energy could be created endlessly; at the same time, the present invention finds the best way to receive the potential energy of the circumferential body including the potential energy zone and protruding stud. Therefore, the “residual energy” is generated. The present invention uses the natural law to obtain the natural energy.

In order to explain the problem, let's go back to the experiment of “rolling cylinder onto the wood board”. The wood board (similar to the protruding stud 21) is under the cylinder, namely in the potential energy zone of the circumferential body. The inventor pulls the spring scale to lift the cylinder off the ground so the cylinder moves onto the wood board. At the moment when the cylinder is lifted off the ground, the required traction force is biggest, which is 4 kg. At this time, the fixed pivot of the cylinder is on one edge of the wood board. The upper extension line of the connection line from this fixed pivot of the circumferential body to the geocenter is the gravity surface of the cylinder. At this moment, the gravity at both sides of the gravity surface is different. The gravity that exerts as driving force is only 4 kg and the gravity that exerts as resistance is 8 kg. And the weight on the wood board is also 8 kg. When the traction from the inventor becomes 4 kg, the driving force is identical to the resistance, and the two forces are balanced. And then a traction force increase a little (greater than zero), the cylinder could move and roll onto the wood board. The terms “4 kg” and “a little” are not accurate enough, but it does not influence the fact and principle analysis to the fact.

Till now, we don't obtain the “residual energy”, the current status is only that “the two forces are balanced, and the cylinder rolls onto the wood board”.

However, the “residual energy” could be obtained by using gravity transforming device of the present invention. The principle is as follows: pulling the cylinder onto the wood board saves only force of 8 kg, and the “residual energy” is not obtained; however, we could let the cylinder fall off from the wood board. And the gravity of the falling cylinder could create the “residual energy”. The gravity of the falling cylinder is 12 kg which is much greater than the traction force of 4 kg which pulls the cylinder onto the wood board. 12−4=8, so the residual energy of 8 kg is generated, and the saved energy is the residual energy. If the thickness of the wood board is reduced and the weight of the cylinder is increased, the efficiency will be higher and the generated residual energy will be much more. Another problem is the way to receive the gravity, which is explained in the section 5.5.

4.3 The present invention uses the natural law to transform the gravitational potential energy.

The same as the wind power generation and hydroelectric generation, the gravity transforming device of the present invention uses the gravity and transforms the gravity into the power, and also uses the natural law, but in different manner. The present invention could effectively transform the gravity, or the present invention is “a machinery that uses gravity to improve energy transforming efficiency”. The gravity is also a kind of energy, the opinion that “gravity is not energy” is apparently wrong. The hydroelectric generation is a typical example that uses the gravity of water, namely the “liquid altitude gravitational potential energy” of water. The fact proves that if there is no gravity, there would not be wind power or water power that is reserved fluid gravity. The “circumferential body” as stated in present invention is solid, which has gravitational potential energy the same as fluid. The only difference is that the gravitational potential energy of “the circumferential body” is a natural “solid altitude gravitational potential energy”. Moreover, the “solid altitude gravitational potential energy” of the circumferential body has some important features:

For example 1 “the gravity at both sides of the gravity surface is identical to each other and opposite in direction”;

For example 2 “no matter how great the mass is, the force to overcome the stationary inertia force is greater than zero”;

For example 3 “the rolling circumferential body stresses same gravity to every bearing point on the way”;

For example 4 “the circumferential body in rolling status could maintain the solid altitude gravitational potential energy”;

For example 5 “the input energy of the rolling circumferential body could be much less than the output energy of the circumferential body”, and etc.

All these features are facts and natural laws that we must respect. These important features of the “solid altitude gravitational potential energy” of the circumferential body are the basic theoretical basis of using the gravity energy. Human beings could utilize the “altitude gravitational potential energy” of the fluid, and the human beings could also utilize the “altitude gravitational potential energy” of the solid of course.

4.4 The following is the embodiment of the FIG. 7. In the Figure of drawings of the specification, a driving gear 16 is provided over the circumferential body 1, and a receiving gear 19 is provided in the potential energy zone under the circumferential body, and diameter of the driving gear is the same as that of the receiving gear. It is assumed that the data of the device is the same as that of the experiment “rolling cylinder onto the wood board”, namely the driving force of the driving gear 16 is 4 kg, weight of the circumferential body 1 is 12 kg, and the height of the receiving gear (namely the protruding stud) protruded out of the bearing surface is 12 mm. Because the diameters of the driving gear and the receiving gear are the same, the rotating speed and stroke of the two should also be the same. Therefore, once the driving gear 16 moves, the receiving gear 19 obtains the gravity of 12 kg immediately; as a result, a residual energy of 8 kg is generated. If the driving gear 16 is used to drive the receiving gear 19 directly, there would be no residual energy generated apparently. If the cylinder is changed to common gear having same diameter, there would also be no residual energy generated. One reason is that the common gear cannot have the weight, and the other is that common gear is fixed by the shaft, so the gravity cannot be transferred. The above fact should be clear enough.

4.5 To deny the present invention, it is indispensable to deny the facts including “rolling cylinder onto the wood board” and “FIG. 7”.

The facts including “rolling cylinder onto the wood board” and “FIG. 7” prove that the gravity transforming device of the present invention is utilizable. The present invention realizes that “the input is less than the output”, namely “the output is greater than the input”. In this experiment, the input energy is only 4 kg, but the gravity output is as much as 12 kg.

Everyone could repeat this experiment and test this fact. It is easy to repeat this experiment: find a cylinder having diameter greater than 10 cm in the office, for example, bucket, vase or tea canister; fill the cylinder with sand, and find a piece of string, a thin book of about 0.5 cm thick and a domestic spring scale; and carry out the experiment according to the method and processes of the experiment “rolling cylinder onto the wood board”; thus this fact could be tested. It is suggested that anyone with different opinion could carry out the experiment.

Actually this experiment is not so necessary, because the science has already tested that rolling the cylinder upwards along the inclined-plane could save more than half of the force.

Apparently, to deny the Circumference Law and gravity transforming device of the present invention, it is indispensable to deny the above facts, including “rolling cylinder onto the wood board” and “FIG. 7”.

5. Without correct understanding of the Circumference Law and the gravity transforming device, there would be the following wrong opinion or prejudice.

5.1 Someone says that the gravitational potential energy of a body does not exist anymore after transforming, extra work is necessary to regain the gravitational potential energy.

The principle is correct, but only half of it is correct. It is correct only in the common theory in the past. But it is not correct for body fact of the circumferential body and circular motion, because it disobeys the fact, laws and science.

After the gravitational potential energy of the circumferential body is transformed, the position of the circumferential body becomes lower, namely it is closer to the geocenter. The gravitational potential energy is lost relatively, so it is undoubted that extra force is needed to help it return to the original position and regain the original gravitational potential energy. However, the present invention could “use extra force that is much smaller than the gravity of the circumferential body or none extra force is needed to lift the circumferential body to the original position (height) and regain the original gravitational potential energy”. And the fact of “FIG. 7” is just like this. “Once the driving gear 16 moves, the receiving gear 19 obtains the gravity of 12 kg immediately, and the residual energy of 8 kg is generated”. It is very important to understand that this is the contribution of the present invention.

The fact proves that the present does not “create the energy out of nothing” and does not “break the law of conservation of energy”. The present invention utilizes the natural law of the circular motion, that is, the Circumference Law.

Apparently, if the Circumference Law cannot be denied, then the gravity transforming device cannot be denied.

5.2 Someone says that “cutting watermelon”, “roly-poly toy” and the “wind-blowing rock” cannot prove the Circumference Law.

The fact of “cutting watermelon” is only necessary to prove the principle that “the fact that the two pieces of watermelon after being cut fall down to two opposite sides could prove gravity direction of the two pieces of watermelon is opposite”. The present invention is not necessary to involve the problems that “after being cut, gravity centers of the two pieces of watermelon are lower, the potential energy thereof disappears, and the motion thereof stops, and so on”. At the same time, the phenomenon cannot deny the above facts proved by the “cutting watermelon” experiment. If the fact that “the fact that the two pieces of watermelon after being cut fall down to two opposite sides could prove gravity direction of the two pieces of watermelon is opposite” cannot be denied, the theory of the present invention is true.

The “roly-poly toy” and the “wind-blowing rock” are the same facts that could prove the First Law of the Circumference Law. Namely, “No matter how great the mass of the roly-poly toy and the wind-blowing rock is, theoretically, the force to overcome the stationary inertia force is greater than zero”. It is enough to prove this point. The problem that “when the external force disappears, motion of the roly-poly toy will stop gradually” is irrelevant to the present application.

5.3 Someone says that “when the external force disappears, while the gravity center of the circumferential body is becoming lower, the potential energy becomes smaller and motion of the circumferential body will stop at last”.

Such phenomenon does not influence the present invention. Motion of the circumferential body in the gravity transforming device is controlled, the circumferential body is provided with a fixed pivot, and the gravitational potential energy of the circumferential body on the fixed pivot does not change. For example, in the facts of “rolling cylinder onto the wood board” and “FIG. 7”, if the cylinder of 12 kg is controlled to fall down on the fixed pivot, apparently the cylinder of 12 kg will keep the weight of 12 kg, namely the pressure of 12 kg to the fixed pivot. And it is still 12 kg till it falls down to the ground. It is enough since the present invention could obtain residual energy as long as the circumferential body has the gravity of 12 kg.

Said gravitational potential energy in the present invention means the gravity and the potential energy which cannot be separated, because the circumferential body has the gravity and the potential energy at the same time. Unless the circumferential body reaches the geocenter, the gravity and the potential energy thereof will disappear.

5.4 Someone says that the factors like friction reduce the gravitational potential energy gradually, and the motion will stop at last.

This would not happen in the present invention. There are two reasons: firstly, the high efficiency is enough to counteract the friction. In the experiment of “rolling cylinder onto the wood board”, the energy of 12 kg is obtained by consuming the energy of 4 kg. The obtained energy is much greater than the consumed energy, and the energy efficiency (energy conversion efficiency) is very high. By reducing friction through reasonable structure and improved accuracy, the energy efficiency could be higher. This high energy efficiency is enough to counteract the friction. Secondly, the friction could be very low and overcome. The phenomenon that “the friction reduces the potential energy” could be totally avoided or reduced to an ignorable degree in the present invention. In the experiment of “rolling cylinder onto the wood board”, weight of the cylinder of 12 kg is 12 kg on the wood board; during the falling process, because the speed is not high, there would not be weight loss, which means that the gravity from the earth does not change and the weight thereof will always be 12 kg. After the cylinder falls down, the gravity from the earth is still the same, the weight thereof, namely its pressure to the fixed pivot or ground is still 12 kg without any loss. During the whole process, the friction loss and potential energy reduction of the circumferential body is so small that it could be ignored. Therefore, the idle work loss like friction will not be fatal obstacle of the present invention, and the present invention could overcome the friction and output a lot of energy.

5.5 Someone says that it is difficult to transform the gravitational potential energy of the circumferential body, and the transforming efficiency is low.

There is condition for transforming gravitational potential energy and generation of residual energy. It is a very difficult problem for human beings to transform the gravitational potential energy for many years. If there is no breakthrough on theory and technique, it is difficult to transform the gravitational potential energy. For example, in the experiment of “rolling cylinder onto the wood board”, if the cylinder rolls off the wood board directly in motion of a free falling body to a spring, the circumferential body cannot return to the wood board, and the gravitational potential energy of the circumferential body is not transformed to another same gravitational potential energy, and there is residual energy recycled. Apparently, this gravity transforming method is not suitable, and the energy transforming device is not reasonable, so it is difficult to transform the gravitational potential energy. In order to obtain the residual energy from the fallen circumferential body, the key point is the energy receiving method, namely the gravitational potential energy transforming method.

What kind of receiving method could be used to generate residual energy? In order to facilitate understanding and explanation, a “teeterboard receiving device” is made: in the experiment of “rolling cylinder onto the wood board”, the cylinder is connected with one end of the teeterboard which is an equal armed lever, namely a lever with the power arm and resisting arm identical in length. When the cylinder of 12 kg falls off from the wood board, another cylinder of 12 kg at the other end of the teeterboard could be lifted to the same height. The teeterboard has same principle with the “balance scale”.

This at least proves that the gravitational potential energy of the circumferential body could be transformed to another same gravitational potential energy during the gravity transforming process. The energy efficiency ratio could be up to 100%. If the cylinder of 12 kg is enlarged for 10 times, the obtained residual energy could be increased for 10 times. As a result, if the task is to lift water, the other end of the teeterboard could lift water of 120 kg; if the task is to carry bricks, the other end of the teeterboard could carry bricks of 120 kg; if the task is to generate electricity, the other end of the teeterboard could be a connecting rod, a rotor of motor, or a mover of a direct drive motor having a force of 120 kg. In short, the conversion of the gravitational potential energy could be realized by using the prior art. The present invention realizes lifting water, carrying bricks and generating electricity at least. The present invention could still improve the improved gravitational potential energy again or for a plurality of times with same method. For example, the water with gravitational potential energy improved for a plurality of times could be used as running water for gravity irrigation and washing streets.

In the actual implementation process, there is idle work loss like friction, but it is too less than the huge residual energy. Moreover, the idle work loss like friction is caused by unreasonable structure and low accuracy, and should be resolved by adjusting the structure and improving accuracy thereof. Therefore, the idle work loss like friction cannot be reason to deny the technical principle and technical proposal of the present invention.

In the acrobatic high altitude performance, a man jumps from a high place to one end of the teeterboard, so as to bounce another man of same weight to an even higher place. Does this disobey the law of conservation of energy? No. Because the man jumping down from the high place has acceleration impulsive force, the power arm of the teeterboard is relatively long, and the teeterboard is flexible; as a result, the impulsive force is enlarged and the loss of energy conversion is small. The high efficiency conversion is what the present invention seeks for. The present invention could use small traction force to make the man who jumps down return to the previous height and regain the potential energy. According to experimental data of the “rolling cylinder onto the wood board”, a driving force of 8 kg could pull the cylinder of 24 kg to roll onto a height of 12 mm, and the cylinder of 24 kg could obtain a residual energy of 16 kg; and the driving force of 16 kg is enough to pull the cylinder of 48 kg to roll onto a height of 12 mm, then the cylinder of 48 kg could obtain a residual energy of 32 kg . . . In this way, enormous energy could be obtained.

From “the rolling cylinder onto the wood board” that creates potential energy, to “the teeterboard receiving device” that receives potential energy, “lifting water, carrying bricks and generating electricity” that transforms potential energy, further to “FIG. 7” and “combined gravity transforming device”, the present invention claims a complete gravity transforming process and a complete technical proposal. The common technician should be able to understand and implement the present invention.

Apparently, to deny the Circumference Law and the gravity transforming device, it is indispensible to deny the above facts and deduction.

6. It is possible to “create residual energy”.

6.1 The residual energy cannot be created by using common theory and method.

In the experiment of “rolling cylinder onto the wood board”, by using an input driving force of 4 kg, a residual energy of 8 kg is obtained. The residual energy of 4 kg could be used to pull the circumferential body to roll onto the wood board, and there is still residual energy of 4 kg could be output. This proves that the gravity transforming device creates residual energy. However, the existing theory disagrees with this. The reason is that the force is saved but the work is not saved. Work=Force×Distance. Stroke of the force of 4 kg is 3 times of stroke (12 mm) of the cylinder, namely 36 mm. 4 kg×36 mm=12 kg×12 mm, namely the work is the same. Only the force is saved, no work is saved, and no energy is saved. Even the combined gravity transforming device cannot do it, because every single device cannot save energy, they cannot save energy after being combined.

However, the inventor believes that the existing theory does not accord with the fact in circular motion.

6.2 The inventor believes that the following three kinds of circular motion could create residual energy.

First: in the experiment of “rolling cylinder onto the wood board”, a power of 4 kg is consumed, and a residual energy of 8 kg is obtained, which proves that the gravity transforming device realizes that the input is less than output and residual energy is created.

Second: the combined gravity transforming device (also called gravity generator) could even create residual energy. The residual energy of the first gravity transforming device is used to pull the second bigger gravity transforming device (namely to pull bigger cylinder), and the residual energy of the second gravity transforming device is used to pull the third bigger gravity transforming device . . . Because the output of every device is greater than the input, the residual energy will be greater and greater, and it could be endless.

Third: in situation that “gravity of the circumferential body is great enough, traction force of the rolling circumferential body is small enough, the time to pull the circumferential body to roll is short enough, and the obtained residual energy is enough”, the residual energy could be created. The above “four enough” is completely possible to realize. The science is on the basis of fact; the following is description of fact evidence.

6.3 The following is a “ten thousand times experiment”.

According to structure of FIG. 10, assuming that the weight of the circumferential body 100000 kg, and the diameter is 50 m; the height of protruding stud in the potential energy zone of the circumferential body is 5 mm (5 mm is enough to meet the stroke requirement of transferring the energy), and the force to pull the circumferential body to roll onto or press down the protruding stud is 10 kg. Namely, rolling the circumferential body once could generate a residual energy of 99999 kg to the protruding stud.

Calculate according to existing theory: 100000 kg is one thousand times of 10 kg, and 50 m is one thousand times of 5 mm. The stroke of 100000 kg is 5 mm, so the stroke of 10 kg should be 50 m. Namely: 100000 kg×5 mm=10 kg×50 m. However, the present invention believes that this calculation according to existing theory is incorrect; the calculation should be according to fact:

Calculate according to circular constant formula: stroke of 10 kg should be 5 mm×3.14=15.7 mm. If a force of 10 kg is used to pull the circumferential body of 100000 kg to roll onto the protruding stud for 5 mm, the equation is: 100000 kg×5 mm=10 kg×15.7 mm. In this equation, the 5 mm stroke of 100000 kg is equal to diameter of the circumferential body, and the 15.7 mm stroke of 10 kg is equal to circumference of the circumferential body. The circumferential body rolls for 15.7 mm in circumference, and moves 5 mm on diameter. Namely when the circumferential body is rolled for 15.7 mm, the height of the circumferential body is increased 5 mm. The equation is apparently a fact. But the work in the equation is totally different. The force difference is ten thousand times, and the stroke difference is 3.14 times. Apparently, the work of 100000 kg×5 mm is too much greater than that of 10 kg×15.7 mm.

The four “enough” could be realized: firstly, in the “ten thousand times experiment”, the “gravity of the circumferential body is great enough, and traction force of the rolling circumferential body is small enough” are realized; secondly, the device in FIG. 7 is set according to data of the “ten thousand times experiment”, so as to achieve the effect of the “ten thousand times experiment”. Moreover, the device in FIG. 7 realizes that “the time to pull the circumferential body to roll is short enough”. In FIG. 7, the driving wheel (namely the driving gear) 16 has the same diameter, rotating speed and stroke as the receiving wheel (namely the receiving gear) 19. Therefore, once the driving wheel 16 moves, the receiving wheel 19 also moves together with it, and the stroke is the same as that of the driving wheel. According to data of the “ten thousand times experiment”, once the driving wheel 16 moves, the receiving wheel 19 obtains the gravity of 10000 kg immediately, and the residual energy of 99999 kg is generated.

In this case, the motion time and stroke of the driving wheel 16 and the receiving wheel 19 are the same, but the momentums and the work generated by the two are different. The obtained work is too much greater than the work consumed. This proves that the existing theory does not match with the fact of the circular motion.

The device in FIG. 7 realizes that “the time to pull the circumferential body to roll is short enough, and the obtained residual energy is enough”, which proves that the present invention could realize the “four enough” at the same time. All of the FIGS. 3, 6, 10 and 12 could realize the “four enough”.

The facts show that the “four enough” could be realized. However, it doesn't matter it is cannot be realized, because the target of the present invention is to “transform gravity effectively”.

6.4 “Riding bicycle” creates residual energy.

In order to facilitate understanding and explanation, we take a section (30 m) of motion that a man rides bicycle on flat ground for analysis. During the motion of 30 m, the man uses very small force, which is much smaller than the weight of the man and the bicycle. The work from the man to the bicycle is much smaller than the work from the bicycle to the ground. For example, on the smooth flat ground, by consuming a force of 10 kg to pedal the crank of the bicycle for a half circle, the man could ride the bicycle to move for 30 m. In this case, the work from the man to the bicycle is 10 kg×0.3 m (half circumference of the crank); however, the work from the bicycle to the ground is 100 kg (weight of the man and the bicycle)×30 m. The difference between the two is 10 times. By consuming a force of 10 kg to the bicycle, a force of 100 kg to the ground is obtained. The force difference is also 10 times, so the energy of the two is apparently different. 100 kg−10 kg=90 kg. Where does this force (energy) of 90 kg come from?

The Circumference Law believes that human pedaling the crank of bicycle and the bicycle wheels rolling on the ground are both circular motion, and obey the Circumference Law and are application of the Circumference Law. The gravity is barely used when the man pedals the bicycle, but the bicycle uses the gravity (weight of the man and the bicycle) to the ground. The two wheels of the bicycle are both circumferential bodies. The gravity of 100 kg is distributed on the two wheels and forms the pressure to the ground. In ideal condition, the gravity at both sides of the gravity surface of the two wheels is equal but opposite in direction, and the force to overcome the stationary inertia force is greater than zero. The First Law of the Circumference Law reflects this situation of circular motion. Because motion of the bicycle is in a non-ideal condition, the force to overcome the stationary inertia force is 10 kg.

Someone says that the force is saved because of rolling friction but not the Circumference Law. However, in the same condition, why does the rolling friction save more force than surface friction? Apparently, the reason is explained in the Circumference Law, namely the gravity surface.

6.5 Difference between the circumferential body and the gear box (including gear group having speed adjustment function) and the lever.

They are all force-saving tools, but have essential differences. Firstly, the gear box has no gravity output, so it could only save force but cannot save energy, which is the most essential reason. Secondly, the structure of the present invention is simpler than that of the gear box. Thirdly, the gear box has no gravity assistance effect. For example, in the experiment of “rolling cylinder onto the wood board”, the gear box could be used to replace the present invention, so as to realize the effect of “using a force of 4 kg to pull the cylinder of 12 kg”; however, this effect cannot be realized if the body to be pulled by the gear box is not a circumferential body, and the energy cannot be saved. If the body to be pulled is a circumferential body, the motion thereof is circular motion; it is much simpler to use a piece of rope rather than the gear box. The situation of the lever is the same as the gear box. Although the present invention could also use devices like gear box, lever and movable pulley, these devices cannot transform the gravity as the present invention, so they cannot be used to replace the present invention.

6.6 The Circumference Law does not disobey the law of conservation of energy.

The Circumference Law believes that, a cylinder that is in line contact with a rigid horizontal bearing surface in ideal condition, no matter how great the mass is, the force to overcome the stationary inertia force is greater than zero. In actual situation, the force to overcome the stationary inertia force is possibly just a little bit greater than zero; for example, the case of “riding bicycle”. The ideal condition does not exist, but it is possible to be infinitely close to the ideal condition. The following is available: the consumed energy is very small, and the obtained energy is very great. Where does this “very great” energy come from? The Circumference Law believes that it is transformed from the “solid altitude gravitational potential energy of the circumferential body”.

1-2. (canceled)

3. A gravity transforming method, characterized in comprising a driving device to drive a circumferential body to move, and a gravity receiving device is provided to transform gravitational potential energy released by the circumferential body into utilizable power; said “drive a circumferential body to move” includes driving the circumferential body to roll or rotate or swing or sway, said “drive a circumferential body to move” enable the circumferential body to continuously recover or release the gravitational potential energy.

4. The gravity transforming method according to claim 3, wherein a driving device is provided to drive the circumferential body to establish the gravitational potential energy, and a gravity receiving device to transmit the gravitational potential energy of the circumferential body to a flywheel that outputs the gravitational potential energy;
Or, wherein a driving device is provided to drive the circumferential body to establish the gravitational potential energy, and the gravity of the circumferential body acts on a pressure sensitive material or a pressure sensitive device; or a gravity transforming device is provided to transform the gravitational potential energy of the circumferential body, said gravity transforming device thereof is a pressure sensitive material or a pressure sensitive device; or said pressure sensitive material includes pressure sensitive ceramic or pressure sensitive silicone or pressure sensitive biological membrane or a pressure sensitive composite membrane; said pressure sensitive device comprises a well-recognized device that produces electrical currents or movements if pressed; said pressure sensitive material or pressure sensitive device, if pressed, produces electrical currents or movements; said pressed includes pulse-type pressed or intermittence-type pressed or impact-type pressed or continuous pressed or rolling pressed; said pulse-type and intermittence indicate their literal meanings to public knowledge; said impact-type pressed means that a circumferential body with a certain speed impacts a pressure sensitive material or pressure sensitive device; said continuous pressed means that gravity of a circumferential body acts on pressure sensitive material or a pressure sensitive device for duration, said duration is no less than 30 seconds; said rolling pressed means that a circumferential body rolls on pressure sensitive material or a pressure sensitive device;
Or, wherein a driving device is provided to drive the circumferential body to establish the gravitational potential energy, and a gravity transforming device is provided to transmit the gravitational potential energy of the circumferential body to a gear box of an oil pumping unit or a belt pulley or a gear or a pull rod; said gear box or belt pulley or gear or pull rod indicates components incorporated into the oil pumping unit for power transmission;
Or, wherein a stand column 7 of a circumferential body 6 is movably connected to a fixed pivot 8, or the stand column 7 of the circumferential body 6 is putted into a socket, and a driving device is provided to drive the circumferential body 6 to swing, and the driving device of the circumferential body 6 includes an electric motor 11, an eccentric wheel 12 and a lever 13, thereof the electric motor 11 is fixed on a door frame 10 mounted on both sides or periphery of the circumferential body 6, the left end of the lever 13 is connected to the eccentric wheel, and its right end movably connected to the stand column 7, while during operation, the eccentric wheel of the electric motor drives the lever 13, and the lever 13 drives the stand column 7 to swing the circumferential body back and forth, a transmitting rod 9 is provided to connected to the circumferential body 6, and the transmitting rod 9 moves up and down with swinging of the circumferential body 6 to transmit the gravity of the circumferential body 6 out; said gravity transforming device comprises an eccentric wheel or a crank that transforms the up-and-down reciprocation of the transmitting rod 9 into rotary motion; or the gravity transforming device includes a magnet connected to the transmitting rod 9, during operation, this magnet generates electricity by moving through the magnetic field lines of a solenoid.
Or, wherein a driving device is provided to drive the circumferential body to establish the gravitational potential energy, in the gravitational potential energy zone of the circumferential body, there is a protruding stud, through which, for receiving gravitational potential energy of the circumferential body and distributing out the gravity energy of the circumferential body;
Or, wherein, on a bearing surface 3, there is a cylinder-shaped circumferential body 1, upon which circumferential body gear 18 is attached, and above circumferential body 1, there is a driving device equipped with a driving gear 16 meshing with the circumferential body gear 18, and in the gravitational potential energy zone of the circumferential body 1, there is a gravity output device with a receiving gear 19, which in the potential energy zone of the circumferential body is meshed with the circumferential body gear 18, and the driving gear 16 drives the circumferential body gear 18, and the circumferential body 1 together with the receiving gear 19 rotates therewith, and the receiving gear 19 drives a generator or a gear box or machinery with power to output the gravity of the circumferential body 1, transforming it into utilizable power; the main body of the receiving gear 19 is mounted beneath the bearing surface, and partial of it are exposed above the bearing surface 3 for meshing with the circumferential body gear 18 and receiving transmission of the circumferential body gear 18, and the receiving gear 19 could also be changed into a friction wheel for friction transmission or a gear and an aperture wheel for tooth-aperture transmission; said tooth-aperture transmission is similar to a structure in which a gear drives a film in a film projector or a camera, whereas the present invention differs in that the tooth and the aperture could be located on the wheel or on a flat plate; as friction transmission is applied, the driving gear 16, the circumferential body gear 18 and the receiving gear 19 could be changed into the friction wheel;
Or, wherein the receiving gear 19 is supplied with power, and is driven by this power during operation, and the circumferential body 1 on the receiving gear 19 rotates therewith, transmitting its gravity to the receiving gear 19, hereby the receiving gear 19 is able to obtain more energy than the driving power; in order to help transmit the gravity of circumferential body 1, one or more propping wheels aligned with the same axle of or its direction of the receiving gear 19, could be provided to push against the circumferential body 1 and withstand its weight;
Or, wherein a driving device of the circumferential body is mounted above the circumferential body, and a receiving rod 26 is mounted beneath the circumferential body, the receiving rod 26 has a pivot 27 of a lever, and one end of the receiving rod 26 is interacting to the gravity transmitting point on the circumferential body to move up and down as the circumferential body rolls back and forth, and the other end of the receiving rod 26 has a gear or friction gear or an aperture wheel to output the gravity of the circumferential body, transforming it into utilizable power;
Or, wherein a circumferential body gear 18 is provided on both ends of the circumferential body, also in the middle of the circumferential body, a touch-down gear 24 is provided with its diameter longer or shorter than or equal to the diameter of the circumferential body 1, the touch-down gear 24 locates on the bearing point gear 23, which undertakes weight of the circumferential body; the structures of the touch-down gear and the bearing point gear could be changed to the structure of slide surface or slide surface, that is, the slide surface of the circumferential body rolls on the bearing; the circumferential body gear 18 could simultaneously drive two receiving devices to output gravity;
Or, wherein a driving device is provided to drive the circumferential body to establish the gravitational potential energy, and a gravity transforming device is provided to transform the gravitational potential energy of the circumferential body into utilizable power, said power is used to generate electricity, or to drive vehicles or drive energy-consuming equipments, and said vehicles include automobile, vessels, trains, airplanes and satellites;
Or, wherein the force to drive the circumferential body is less than the gravity outputted by the circumferential body;
Or, wherein said circumferential body is a sphere, a cylinder and a non-circular body, including a rolling or rotating or swinging or shaking object; the non-circular body includes an object with a circular arc-shaped bottom surface or an object in shaking or swinging or swaying manner; said circumferential body could be of multi-functions as a barn or coal yard or storeroom; a house or a barn or a good yard as such could be a circumferential body or a portion of the circumferential body; weight or volume of the circumferential body could be determined as required; the circumferential body could has a protruding structure 5; Said circumferential body is an object having a gravity surface; the circumferential body is of solid with gravitational potential energy of an attitude; the circumferential body could be made of one or combination of such materials as metal, plastic, stone, mud, resin material and concrete and so on; said circumferential body could be solid or hollow; or the hollow circumferential body has a plurality of cells therein, in which movable liquid or sphere or cylinder that serves as balance weight is provided; a house, an ore, a barn, a vehicle and a liquid each could serve as a portion of the circumferential body; the inner space of the circumferential body could accommodate human beings or animals; or, the circumferential body is comprised of two portions or a plurality of portions; or the circumferential body, in alignment of its axial direction, is divided into a plurality of segments, which are connected in series; or there are centering wheels in the periphery of the circumferential body, the centering wheels could be elastic; or said centering wheel is elastic; Or one or more propping wheels in the same axle of the receiving gear 19 or its axle direction could be fixed; or the circumferential body is seated upon the bearing base; the bearing base means the base to support the circumferential body and its associated equipments or facilities, and it is composed of one or combination of the materials including metal, plastics, stone, mud, resin material, concrete and so on; or said bearing base could be a track or a rigid table board; or said door frame 10 mounted nearby the circumferential body has two or more stand columns flanking on both sides or at periphery of the circumferential body, there is a beam connected to stand columns thereupon, so that the door frame could be in a “Π” shape or a frame shape, and the door frame could be replaced with walls and roof of a building or house nearby the circumferential body, the door frame 10 provides basic conditions for mounting or moving the circumferential body or its associated machinery or equipments, and the door frame 10 could be composed of one or combination of materials including metal, plastic, stone, mud, resin, concrete and so on; or said circumferential body is equipped with a position-limiting device or a position-return device, said position-return device could be a return spring or a return pile or a return wheel or a return edge; the velocity of the circumferential body's motion could be set as required; Or, wherein said driving device includes a power device and a transmission device; said power device includes an electric motor or a combustion engine or man power or animal power or wind power or water power or magnetic force; said transmission device includes gear transmission device or rack-and-pinion transmission device or belt drive device or friction drive device or cam drive device;
Or, wherein said protruding stud could be made of metal, which protrudes out of the bearing surface and interacts with gravity transmitting point on the circumferential body; the shape of the protruding stud could be pile-like or column-like or semicircular or triangular; the protruding stud could be equipped with a return spring, so that it could be pressed down or bounces up in accord with the circumferential body's rolling; or, reciprocating motion of the protruding stud, by means of an eccentric wheel device or an crankshaft device or an rack-and-pinion device, is turn into rotary motion, which drives an electric motor or a gear box or flywheel or machinery/equipment with power to transform the gravitational energy of the circumferential body into utilizable power; or, the protruding stud is connected to a magnet, which is driven by up-and-down reciprocating of the protruding stud to move through the magnetic field lines for generating electricity and transforming gravity of the circumferential body into utilizable power; or, in said gravity transforming method, the output of energy is greater than the input of energy; the protruding stud could be changed into a receiving wheel, a receiving plate, a receiving rod, a receiving lever or a receiving connecting rod; said receiving wheel could be gear, belt pulley, tooth-aperture wheel or friction wheel; said receiving plate is plate-like; said receiving rod is rod-like; said receiving lever is lever-like; said receiving connecting rod could be connected to the center of the circumferential body to drive the crankshaft; or, the protruding stud on the bearing surface of the circumferential body protrudes its height 0.5 mm or more; or the distance from the protruding stud to the vertical central line of the circumferential body is equal to or greater than 0.5 mm; or, wherein the protruding stud locates beneath the bearing surface of the circumferential body, and a corresponding protruding structure is provided on the circumferential body; said potential energy zone means the zone beneath the circumferential body;
Or, wherein said gravity output device includes a gravity transferring device and a gravity receiving device; said gravity transferring device includes a gravity transmitting point or a gravity transferring lever or a gravity transferring rod or a gravity transferring wheel; said gravity transferring lever is in the shape of lever, and could be suspended upon the circumferential body; said gravity transferring rod is in the shape of rod, and is connected to the circumferential body; there may be a plurality of transferring levers or rods, and accordingly there are a plurality of devices to receive the transmission; said gravity transferring wheel includes a gear or a pulley or a friction wheel or a chain wheel or tooth-aperture wheel; said gravity receiving device includes the gravity receiving lever or the gravity receiving protruding stud or the gravity receiving wheel; said gravity receiving wheel includes a gravity receiving gear or a gravity receiving friction wheel or a belt wheel or a gravity receiving chain wheel or a gravity receiving tooth-aperture wheel; said tooth-aperture wheel is a tooth-aperture wheel by tooth-aperture transmitting, and said gravity receiving wheel could be equipped with ratchet wheel device;
Or, wherein said gravity receiving device could be an eccentric wheel or a crank, which transforms the reciprocating motion of the transferring device into rotary motion to drive a generator or a gear box or a machinery/equipment with power; and the gravity receiving device could also be a magnet connected to a transferring rod; during operation, the magnet moves up and down, passing through magnetic field line of the solenoid; Or, wherein there are a plurality of circumferential bodies to operate simultaneously; or, a plurality of circumferential bodies are connected together and driven by one driving device; or, said gravity transforming device could be mounted underground or semi-underground.

5. A gravity transforming device, characterized in comprising a driving device to drive a circumferential body to move, and a gravity receiving device is provided to transform gravitational potential energy released by the circumferential body into utilizable power; said “drive a circumferential body to move” includes driving the circumferential body to roll or rotate or swing or sway, said “drive a circumferential body to move” enable the circumferential body to continuously recover or release the gravitational potential energy.

6. The gravity transforming device according to claim 3, wherein a driving device is provided to drive the circumferential body to establish the gravitational potential energy, and a gravity receiving device to transmit the gravitational potential energy of the circumferential body to a flywheel that outputs the gravitational potential energy;
Or wherein a driving device is provided to drive the circumferential body to establish the gravitational potential energy, and the gravity of the circumferential body acts on a pressure sensitive material or a pressure sensitive device; or a gravity transforming device is provided to transform the gravitational potential energy of the circumferential body, said gravity transforming device thereof is a pressure sensitive material or a pressure sensitive device; or said pressure sensitive material includes pressure sensitive ceramic or pressure sensitive silicone or pressure sensitive biological membrane or a pressure sensitive composite membrane; said pressure sensitive device comprises a well-recognized device that produces electrical currents or movements if pressed; said pressure sensitive material or pressure sensitive device, if pressed, produces electrical currents or movements; said pressed includes pulse-type pressed or intermittence-type pressed or impact-type pressed or continuous pressed or rolling pressed; said pulse-type and intermittence indicate their literal meanings to public knowledge; said impact-type pressed means that a circumferential body with a certain speed impacts a pressure sensitive material or pressure sensitive device; said continuous pressed means that gravity of a circumferential body acts on pressure sensitive material or a pressure sensitive device for duration, said duration is no less than 30 seconds; said rolling pressed means that a circumferential body rolls on pressure sensitive material or a pressure sensitive device;
Or wherein a driving device is provided to drive the circumferential body to establish the gravitational potential energy, and a gravity transforming device is provided to transmit the gravitational potential energy of the circumferential body to a gear box of an oil pumping unit or a belt pulley or a gear or a pull rod; said gear box or belt pulley or gear or pull rod indicates components incorporated into the oil pumping unit for power transmission;
Or wherein a stand column 7 of a circumferential body 6 is movably connected to a fixed pivot 8, or the stand column 7 of the circumferential body 6 is putted into a socket, and a driving device is provided to drive the circumferential body 6 to swing, and the driving device of the circumferential body 6 includes an electric motor 11, an eccentric wheel 12 and a lever 13, thereof the electric motor 11 is fixed on a door frame 10 mounted on both sides or periphery of the circumferential body 6, the left end of the lever 13 is connected to the eccentric wheel, and its right end movably connected to the stand column 7, while during operation, the eccentric wheel of the electric motor drives the lever 13, and the lever 13 drives the stand column 7 to swing the circumferential body back and forth, a transmitting rod 9 is provided to connected to the circumferential body 6, and the transmitting rod 9 moves up and down with swinging of the circumferential body 6 to transmit the gravity of the circumferential body 6 out; said gravity transforming device comprises an eccentric wheel or a crank that transforms the up-and-down reciprocation of the transmitting rod 9 into rotary motion; or the gravity transforming device includes a magnet connected to the transmitting rod 9, during operation, this magnet generates electricity by moving through the magnetic field lines of a solenoid.
Or wherein a driving device is provided to drive the circumferential body to establish the gravitational potential energy, in the gravitational potential energy zone of the circumferential body, there is a protruding stud, through which, for receiving gravitational potential energy of the circumferential body and distributing out the gravity energy of the circumferential body;
Or wherein, on a bearing surface 3, there is a cylinder-shaped circumferential body 1, upon which circumferential body gear 18 is attached, and above circumferential body 1, there is a driving device equipped with a driving gear 16 meshing with the circumferential body gear 18, and in the gravitational potential energy zone of the circumferential body 1, there is a gravity output device with a receiving gear 19, which in the potential energy zone of the circumferential body is meshed with the circumferential body gear 18, and the driving gear 16 drives the circumferential body gear 18, and the circumferential body 1 together with the receiving gear 19 rotates therewith, and the receiving gear 19 drives a generator or a gear box or machinery with power to output the gravity of the circumferential body 1, transforming it into utilizable power; the main body of the receiving gear 19 is mounted beneath the bearing surface, and partial of it are exposed above the bearing surface 3 for meshing with the circumferential body gear 18 and receiving transmission of the circumferential body gear 18, and the receiving gear 19 could also be changed into a friction wheel for friction transmission or a gear and an aperture wheel for tooth-aperture transmission; said tooth-aperture transmission is similar to a structure in which a gear drives a film in a film projector or a camera, whereas the present invention differs in that the tooth and the aperture could be located on the wheel or on a flat plate; as friction transmission is applied, the driving gear 16, the circumferential body gear 18 and the receiving gear 19 could be changed into the friction wheel;
Or, wherein the receiving gear 19 is supplied with power, and is driven by this power during operation, and the circumferential body 1 on the receiving gear 19 rotates therewith, transmitting its gravity to the receiving gear 19, hereby the receiving gear 19 is able to obtain more energy than the driving power; in order to help transmit the gravity of circumferential body 1, one or more propping wheels aligned with the same axle of or its direction of the receiving gear 19, could be provided to push against the circumferential body 1 and withstand its weight;
Or, wherein a driving device of the circumferential body is mounted above the circumferential body, and a receiving rod 26 is mounted beneath the circumferential body, the receiving rod 26 has a pivot 27 of a lever, and one end of the receiving rod 26 is interacting to the gravity transmitting point on the circumferential body to move up and down as the circumferential body rolls back and forth, and the other end of the receiving rod 26 has a gear or friction gear or an aperture wheel to output the gravity of the circumferential body, transforming it into utilizable power;
Or, wherein a circumferential body gear 18 is provided on both ends of the circumferential body, also in the middle of the circumferential body, a touch-down gear 24 is provided with its diameter longer or shorter than or equal to the diameter of the circumferential body 1, the touch-down gear 24 locates on the bearing point gear 23, which undertakes weight of the circumferential body; the structures of the touch-down gear and the bearing point gear could be changed to the structure of slide surface or slide surface, that is, the slide surface of the circumferential body rolls on the bearing; the circumferential body gear 18 could simultaneously drive two receiving devices to output gravity;
Or, wherein a driving device is provided to drive the circumferential body to establish the gravitational potential energy, and a gravity transforming device is provided to transform the gravitational potential energy of the circumferential body into utilizable power, said power is used to generate electricity, or to drive vehicles or drive energy-consuming equipment, and said vehicles include automobile, vessels, trains, airplanes and satellites;
Or, wherein the force to drive the circumferential body is less than the gravity outputted by the circumferential body;
Or, wherein said circumferential body is a sphere, a cylinder and a non-circular body, including a rolling or rotating or swinging or shaking object; the non-circular body includes an object with a circular arc-shaped bottom surface or an object in shaking or swinging or swaying manner; said circumferential body could be of multi-functions as a barn or coal yard or storeroom; a house or a barn or a good yard as such could be a circumferential body or a portion of the circumferential body; weight or volume of the circumferential body could be determined as required; the circumferential body could has a protruding structure 5; Said circumferential body is an object having a gravity surface; the circumferential body is of solid with gravitational potential energy of an attitude; the circumferential body could be made of one or combination of such materials as metal, plastic, stone, mud, resin material and concrete and so on; said circumferential body could be solid or hollow; or the hollow circumferential body has a plurality of cells therein, in which movable liquid or sphere or cylinder that serves as balance weight is provided; a house, an ore, a barn, a vehicle and a liquid each could serve as a portion of the circumferential body; the inner space of the circumferential body could accommodate human beings or animals; or, the circumferential body is comprised of two portions or a plurality of portions; or the circumferential body, in alignment of its axial direction, is divided into a plurality of segments, which are connected in series; or there are centering wheels in the periphery of the circumferential body, the centering wheels could be elastic; or said centering wheel is elastic; Or one or more propping wheels in the same axle of the receiving gear 19 or its axle direction could be fixed; or the circumferential body is seated upon the bearing base; the bearing base means the base to support the circumferential body and its associated equipment or facilities, and it is composed of one or combination of the materials including metal, plastics, stone, mud, resin material, concrete and so on; or said bearing base could be a track or a rigid table board; or said door frame 10 mounted nearby the circumferential body has two or more stand columns flanking on both sides or at periphery of the circumferential body, there is a beam connected to stand columns thereupon, so that the door frame could be in a “Π” shape or a frame shape, and the door frame could be replaced with walls and roof of a building or house nearby the circumferential body, the door frame 10 provides basic conditions for mounting or moving the circumferential body or its associated machinery or equipment, and the door frame 10 could be composed of one or combination of materials including metal, plastic, stone, mud, resin, concrete and so on; or said circumferential body is equipped with a position-limiting device or a position-return device, said position-return device could be a return spring or a return pile or a return wheel or a return edge; the velocity of the circumferential body's motion could be set as required; Or, wherein said driving device includes a power device and a transmission device; said power device includes an electric motor or a combustion engine or man power or animal power or wind power or water power or magnetic force; said transmission device includes gear transmission device or rack-and-pinion transmission device or belt drive device or friction drive device or cam drive device;
Or, wherein said protruding stud could be made of metal, which protrudes out of the bearing surface and interacts with gravity transmitting point on the circumferential body; the shape of the protruding stud could be pile-like or column-like or semicircular or triangular; the protruding stud could be equipped with a return spring, so that it could be pressed down or bounces up in accord with the circumferential body's rolling; or, reciprocating motion of the protruding stud, by means of an eccentric wheel device or an crankshaft device or an rack-and-pinion device, is turn into rotary motion, which drives an electric motor or a gear box or flywheel or machinery/equipment with power to transform the gravitational energy of the circumferential body into utilizable power; or, the protruding stud is connected to a magnet, which is driven by up-and-down reciprocating of the protruding stud to move through the magnetic field lines for generating electricity and transforming gravity of the circumferential body into utilizable power; or, in said gravity transforming method, the output of energy is greater than the input of energy; the protruding stud could be changed into a receiving wheel, a receiving plate, a receiving rod, a receiving lever or a receiving connecting rod; said receiving wheel could be gear, belt pulley, tooth-aperture wheel or friction wheel; said receiving plate is plate-like; said receiving rod is rod-like; said receiving lever is lever-like; said receiving connecting rod could be connected to the center of the circumferential body to drive the crankshaft; or, the protruding stud on the bearing surface of the circumferential body protrudes its height 0.5 mm or more; or the distance from the protruding stud to the vertical central line of the circumferential body is equal to or greater than 0.5 mm; or, wherein the protruding stud locates beneath the bearing surface of the circumferential body, and a corresponding protruding structure is provided on the circumferential body; said potential energy zone means the zone beneath the circumferential body;
Or, wherein said gravity output device includes a gravity transferring device and a gravity receiving device; said gravity transferring device includes a gravity transmitting point or a gravity transferring lever or a gravity transferring rod or a gravity transferring wheel; said gravity transferring lever is in the shape of lever, and could be suspended upon the circumferential body; said gravity transferring rod is in the shape of rod, and is connected to the circumferential body; there may be a plurality of transferring levers or rods, and accordingly there are a plurality of devices to receive the transmission; said gravity transferring wheel includes a gear or a pulley or a friction wheel or a chain wheel or tooth-aperture wheel; said gravity receiving device includes the gravity receiving lever or the gravity receiving protruding stud or the gravity receiving wheel; said gravity receiving wheel includes a gravity receiving gear or a gravity receiving friction wheel or a belt wheel or a gravity receiving chain wheel or a gravity receiving tooth-aperture wheel; said tooth-aperture wheel is a tooth-aperture wheel by tooth-aperture transmitting, and said gravity receiving wheel could be equipped with ratchet wheel device;
Or, wherein said gravity receiving device could be an eccentric wheel or a crank, which transforms the reciprocating motion of the transferring device into rotary motion to drive a generator or a gear box or a machinery/equipment with power; and the gravity receiving device could also be a magnet connected to a transferring rod; during operation, the magnet moves up and down, passing through magnetic field line of the solenoid; Or, wherein there are a plurality of circumferential bodies to operate simultaneously; or, a plurality of circumferential bodies are connected together and driven by one driving device; or, said gravity transforming device could be mounted underground or semi-underground.
